(19) United States
(12) Patent Application Publication
(10) Pub. No.: US 2025/0254571 A1
(43) Pub. Date: Aug. 7, 2025

(54) SUPPORTING CELL RESELECTION OF A NEW SERVING CELL FOR A UE

(71) Applicant: CANON KABUSHIKI KAISHA, Tokyo (JP)

(72) Inventors: Pierre VISA, Rennes (FR); Yacine EL KOLLI, Rennes (FR); Walaa SAHYOUN, Rennes (FR)

(21) Appl. No.: 18/854,913

(22) PCT Filed: Mar. 30, 2023
(86) PCT No.: PCT/EP2023/058341

§ 371 Date: Oct. 7, 2024

(30) Foreign Application Priority Data
Apr. 7, 2022 (GB) 2205138.7
Aug. 9, 2022 (GB) 2211599.2

(51) Int. Cl. H04W 36/00; H04W 36/08; H04W 76/19; H04W 76/20

(52) U.S. Cl. CPC H04W 36/0007; H04W 36/08; H04W 76/19; H04W 76/20

(57) ABSTRACT

A method for supporting cell reselection for a User Equipment, UE, operating in a non-connected RRC state with one or more active data sessions is described. The method at the UE comprises: sending a reselection request message for requesting cell reselection to a new serving cell for receiving the one or more active data sessions from a target base station of the new serving cell; receiving a configuration message including configuration information associated with the target base station for the one or more active data sessions; configuring the UE for receiving data of the one or more active data sessions from the target base station in the new serving cell based on the configuration information. The active data sessions may include one or more Multicast Broadcast Service, MBS, sessions.

### CROSS-REFERENCE TO RELATED APPLICATIONS

The application is the National Phase application of PCT Application No. PCT/EP2023/058341, titled “Supporting Cell Reselection of a New Serving Cell for a UE,” which was filed on Mar. 30, 2023 and which claims priority to United Kingdom Patent Application No. 2205138.7, titled “Supporting Cell Reselection of a New Serving Cell for a UE,” which was filed on Apr. 7, 2022, and to United Kingdom Patent Application No. 2211599.2, titled “Supporting Cell Reselection of a New Serving Cell for a UE,” which was filed on Aug. 9, 2022. Each of the above cited patent applications is incorporated herein by reference in its entirety.

### FIELD OF THE INVENTION

The present invention generally relates to supporting cell reselection of a new serving cell for a User Equipment (UE) of a wireless communication system and particularly to methods performed at the UE, source base station and target base station as part of a reselection process. Cell reselection by a UE may be used when handling mobility of the UE receiving Multicast/Broadcast Service (MBS) in 5G New Radio (NR) systems.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations.

Examples of such wireless multiple-access communication systems include systems based on 3rd generation partnership project (3GPP®) standards, such as fourth-generation (4G) Long Term Evolution (LTE) or recent fifth-generation (5G) New Radio (NR) systems, or systems based on IEEE 802.11 standards, such as Wi-Fi.

Among the requirements for 5G NR, there are service requirements related to multicast and broadcast service, abbreviated as MBS.

For broadcast communication service, the same service and the same specific content data are provided simultaneously to all UEs in a geographical area (i.e. all UEs in the broadcast service area are authorized to receive the data). A broadcast communication service is delivered to the UEs using a broadcast session. For multicast communication service, the same service and the same specific content data are provided simultaneously to a dedicated set of UEs (i.e., not all UEs in the multicast service area are authorized to receive the data). A multicast communication service is delivered to the UEs using a multicast session.

The support of multicast/broadcast techniques enable the network to operate in a more efficient manner than unicast. The identified use cases that could benefit from this MBS feature include public safety and mission critical, V2X applications, IPTV, live video, software delivery over wireless and IoT applications. 3GPP started to build functional support of MBS in 5G NR with Release 17.

In 5G NR, Radio Resource Control (RRC) protocol operates in the control plane between a UE and a base station (gNB), and provides 3 different states for a UE as defined in the 3GPP specifications TS 38.331: RRC_CONNECTED, RRC_INACTIVE, and RRC_IDLE states. At power up, a UE is in RRC_IDLE state, and the UE changes to RRC_CONNECTED state upon an RRC connection establishment with a gNB. If the RRC connection is released then the UE changes back to RRC_IDLE state. When in RRC_CONNECTED state, the RRC connection can be suspended by the gNB, and the UE moves to RRC_INACTIVE state. When the UE is in RRC_INACTIVE state it cannot communicate with the 5G system, but both the gNB and the UE keep track of the RRC connection context. Thus, the transition back to the RRC_CONNECTED state from the RRC_INACTIVE state is faster than the RRC connection establishment from RRC_IDLE to RRC_CONNECTED state.

With the 3GPP Release 17, the reception of MBS broadcast by a UE is allowed when the UE is in RRC_IDLE, RRC_INACTIVE, or RRC_CONNECTED state, and the reception of MBS multicast is allowed when the UE is in RRC_CONNECTED state only. For the Release 18, the plan is to further allow the MBS multicast reception when the UE is in RRC_INACTIVE state. See, for example, 3GPP RP-213568 entitled “New WID: Enhancements of NR Multicast and Broadcast Services” submitted by CATT and entitled (3GPP TSG RAN Meeting #94-e, source CATT), section 3. The objective is to enable a large density of UEs to be receiving multicast data from one cell. Indeed, having UEs in RRC_INACTIVE state leads to a downsize in the control plane footprint of the overall UEs, and thus allows the gNB to handle more UEs. Besides, to always keep UEs in RRC_CONNECTED state is not power efficient. As a result, the advantages of also supporting multicast for UEs in RRC_INACTIVE state have been recognised.

The establishment of MBS session in a UE can be performed when the UE is in RRC_CONNECTED state. The UE may then be set to RRC_INACTIVE state by the serving gNB while still receiving the MBS data. However, one issue with a UE receiving MBS multicast or broadcast in RRC_INACTIVE state, is the handling of mobility, where a mobile UE is moving from one cell managed by a source gNB to another cell managed by a target gNB, with the aim to maintain the continuity of service (or at least to minimize the data loss). The mobility procedure to migrate from one cell to another depends on the UE's RRC state. In RRC_CONNECTED state, the mobility procedure is called handover and it is triggered by the source gNB based on the measurement reports provided by the UE. With the handover procedure, the network (i.e. the source gNB, the target gNB and the 5G core network (5GC)) controls the procedure to ensure the delivery of MBS data through the target gNB. In RRC_INACTIVE state (and in RRC_IDLE state), the mobility procedure is called cell reselection, and it is managed by the UE itself. In the cell reselection process, a UE periodically evaluates the radio conditions and selects a suitable cell for camping on.

As there is no communication with the network in the cell reselection process, several issues may prevent a UE from continuing to receive the MBS data after cell reselection. First, the UE may select a target gNB that is out of the MBS service area, thus the target gNB is not a base station able to deliver the MBS service the UE is interested in. When the target gNB can provide the same MBS service, another issue for the UE is to get the configuration information to receive the MBS data. One solution could be to switch the UE in RRC_CONNECTED state and to apply the handover procedure. However, this would remove the benefits of keeping the UE in RRC_INACTIVE or RRC_IDLE state (e.g. as discussed above).

For MBS broadcast, the 3GPP Release 17 provides some solutions to enable a UE to stay in RRC_INACTIVE or RRC_IDLE state and to continue receiving MBS broadcast service after cell reselection. Actually, MBS broadcast configuration information is provided on MBS Control Channel (MCCH). MCCH carries the MBSBroadcastConfiguration message which indicates the MBS broadcast sessions that are provided in the cell as well as the corresponding scheduling related information for these sessions. Optionally, the MBSBroadcastConfiguration message may also contain a list of neighbor cells providing the same broadcast MBS service(s) as provided in the current cell. The MCCH information (i.e. information transmitted in messages sent over MCCH) is transmitted periodically, using a configurable repetition period and within a configured transmission window. The configuration information required by the UE to receive MCCH is provided in a System Information Block (SIB) broadcasted to all UEs. Additionally, another SIB broadcasted to all UEs also provides an information related to service continuity of MBS broadcast, i.e. the mapping between frequency and MBS services. Based on the list of neighbor cells providing the same broadcast MBS service(s), a UE can select a suitable cell in the cell reselection process. Then, based on the configuration information broadcasted in the suitable cell, the UE can configure its user plane to continue receiving the MBS broadcast data. However, these solutions for MBS broadcast cannot be reused for MBS multicast. As an MBS multicast service may be reserved to a restricted set of UEs having the authorization to receive it (e.g. a particular multicast group), all the configuration information for MBS multicast reception cannot be made available to all UEs like for MBS broadcast. Even if the target gNB is sending MBS multicast data from the same MBS session, the UE does not know the proper configuration of the MBS Radio Bearer used by the target gNB and so is not able to receive the MBS multicast data from the target gNB.

In summary, RAN, in 3GPP Release 17, only specifies multicast for UEs in RRC_CONNECTED state, which may not fully fulfil the requirements of, e.g., Mission Critical Services, especially for cells with a large number of UEs according to TR 23.774. Also, to always keep UEs in RRC_CONNECTED state is not power efficient (e.g. as discussed above).

Accordingly, it is desirable to provide at least one solution, for example for a UE receiving MBS multicast data in a non-connected RRC state, to ensure continuity of MBS service is maintained or at least data loss is minimised when the UE performs cell reselection and switches to a new serving cell. Thus, for example, it is desirable to support multicast for UEs in RRC_INACTIVE.

### SUMMARY

In accordance with a first aspect of the present invention, there is provided a method for supporting cell reselection for a User Equipment, UE, the UE operating in a non-connected RRC state with one or more active MBS multicast sessions, the method at the UE comprising: sending a request message for receiving the one or more active MBS multicast sessions from a target base station of the new serving cell; receiving a configuration message including configuration information associated with the target base station for the one or more active MBS multicast sessions, the configuration information including MBS bearer configuration information for the one or more active MBS multicast sessions in the new serving cell; configuring the UE for receiving data of the one or more active MBS multicast sessions from the target base station in the new serving cell based on the configuration information.

The UE may switch to the new serving cell either before or after the reselection request is sent. After the UE is configured and after the UE switches to the new serving cell (which switching may occur either before or after the reselection request is sent), the UE may receive, from the target base station, data for the one or more active data sessions.

The UE may send the reselection request message (or notification) to a RAN node such as the source base station of a serving cell or the target base station of the new serving cell.

In accordance with another aspect of the invention, there is provided a method at a target base station of a new serving cell of a User Equipment, UE, the UE operating in a non-connected RRC state with one or more active MBS multicast sessions, the UE having switched from a previous serving cell to the new serving cell, the method comprising: receiving, from the UE, a request message for receiving the one or more active MBS multicast sessions from the target base station of the new serving cell; sending, to a source base station of the previous serving cell, a context request message; receiving, from the source base station, a context message including context information associated with the UE and the one or more active MBS multicast sessions; sending, to the UE, a configuration message including configuration information associated with the target base station for the one or more active MBS multicast sessions, the configuration information including MBS bearer configuration information for the one or more active MBS multicast sessions in the new serving cell.

In an example, the UE may be in a RRC_INACTIVE state.

By sending the reselection request message for requesting cell reselection to a new serving cell for receiving the one or more active data sessions from a target base station of the new serving cell, and receiving configuration in response, the UE is able to obtain the configuration information required to receive data of the one or more active data sessions via the target base station which ensures continuity of data service (e.g. MBS service) is maintained or at least data loss is minimised when the UE performs cell reselection and switches to a new serving cell. This facilitates the handling of mobility for the UE receiving MBS multicast in RRC_INACTIVE state. Furthermore, providing a method performed whilst the UE is in a non-connected RRC state means that the UE does not have to be switched to the RRC_CONNECTED state to apply the handover procedure and thus, the benefits of keeping the UE in the non-connected RRC state (e.g. reduced control plane footprint) are maintained.

Thus, the UE in the non-connected RRC state can switch to a new serving cell while still receiving one or more active data sessions (e.g. MBS service(s)).

Furthermore, as the target base station is informed of a new UE in a non-connected RRC state that is requesting cell reselection to the target base station and to receive one or more active data session (e.g. MBS service(s)) from the target base station, the handling of mobility for the UE receiving MBS multicast in RRC_INACTIVE state to setup the one or more active sessions at the target base station can be properly managed: for example, to control that the UE is authorized to receive the MBS multicast, and if needed, to request the core network to provide the MBS data to the target base station.

In accordance with another aspect of the present invention, there is provided an apparatus for a UE comprising: one or more processing units configured, when the UE operates in a non-connected RRC state with one or more active MBS multicast sessions, to: send a request message for receiving the one or more active MBS multicast sessions from a target base station of a new serving cell; receive a configuration message including configuration information associated with the target base station for the one or more active MBS multicast sessions, the configuration information including MBS bearer configuration information for the one or more active MBS multicast sessions in the new serving cell; configure the UE for receiving data of the one or more active MBS multicast sessions from the target base station in the new serving cell based on the configuration information.

In accordance with another aspect of the present invention, there is provided an apparatus for a base station comprising one or more processing units configured, when the base station controls a new serving cell of a UE operating in a non-connected RRC state with one or more active MBS multicast sessions, the UE having switched from a previous serving cell to the new serving cell, to: receive, from the UE, a request message for receiving the one or more active MBS multicast sessions from the target base station of the new serving cell; send, to a source base station of the previous serving cell, a context request message; receive, from the source base station, a context message including context information associated with the UE and the one or more active MBS multicast sessions; send, to the UE, a configuration message including configuration information associated with the target base station for the one or more active MBS multicast sessions, the configuration information including MBS bearer configuration information for the one or more active MBS multicast sessions in the new serving cell.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by a processing unit, cause the processing unit to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIGS. 1a, and 1b are schematic diagrams illustrating a first example wireless communication system in which the present invention may be implemented according to one or more embodiments of the invention;

FIGS. 1c, and 1d are schematic diagrams illustrating a second example wireless communication system in which the present invention may be implemented according to one or more embodiments of the invention;

FIG. 2 illustrates a block schematic diagram of an example configuration of a UE in which the present invention may be implemented according to one or more embodiments of the invention;

FIG. 3 illustrates a block schematic diagram of an example configuration of a base station in which the present invention may be implemented according to one or more embodiments of the invention;

FIG. 4 is a flowchart showing the RRC connection states and transitions for a UE in 5G NR systems;

FIG. 5 is a simplified flowchart illustrating the handover procedure while a UE is receiving MBS multicast data in RRC_CONNECTED state;

FIG. 6 is a flowchart illustrating an example cell reselection procedure for a UE in RRC_INACTIVE state and receiving MBS multicast data, according to a first embodiment of the invention;

FIG. 7 is a flowchart illustrating an example cell reselection procedure for a UE in RRC_INACTIVE state and receiving MBS multicast data, according to a second embodiment of the invention;

FIGS. 8a and 8b are flowcharts illustrating example methods performed at a UE in RRC_INACTIVE state for cell reselection while receiving MBS multicast data, in accordance with embodiments of the invention;

FIGS. 9a and 9b are flowcharts illustrating example methods performed at a source base station to support cell reselection of a UE in RRC_INACTIVE state and receiving MBS multicast data, in accordance with embodiments of the invention;

FIGS. 10a and 10b are flowcharts illustrating example methods performed at a target base station to support cell reselection of a UE in RRC_INACTIVE state and receiving MBS multicast data, in accordance with embodiments of the invention;

FIG. 11 is a flowchart of a method, performed by a UE, for supporting cell reselection for a UE in accordance with embodiments of the invention;

FIG. 12 is a flowchart of a method, performed by a source base station, for supporting cell reselection for a UE operating in a non-connected RRC state with one or more active data sessions, in accordance with an embodiment of the invention;

FIG. 13 is a flowchart of a method, performed by a target base station, for supporting cell reselection for a UE operating in a non-connected RRC state with one or more active data sessions, in accordance with another embodiment of the invention;

FIG. 14 is a flowchart of a method, performed by a target base station, for supporting cell reselection for a UE operating in a non-connected RRC state with one or more active data sessions, in accordance with the embodiment of the invention.

### DETAILED DESCRIPTION

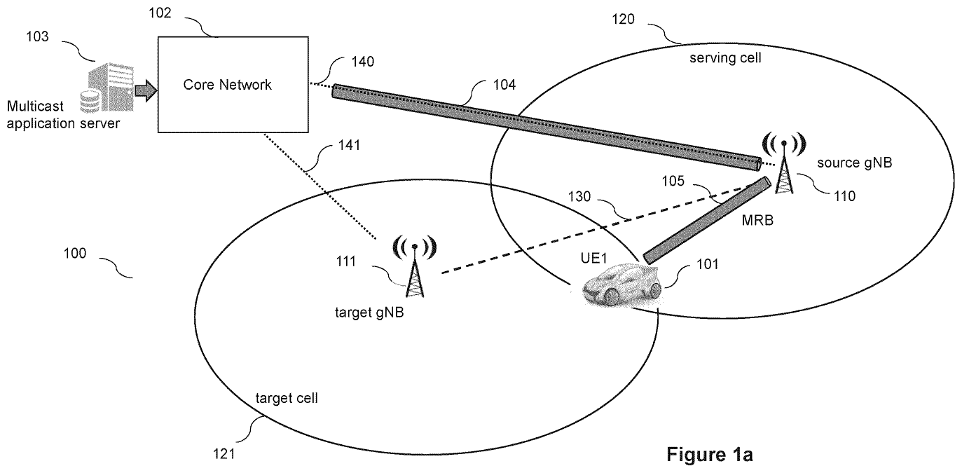

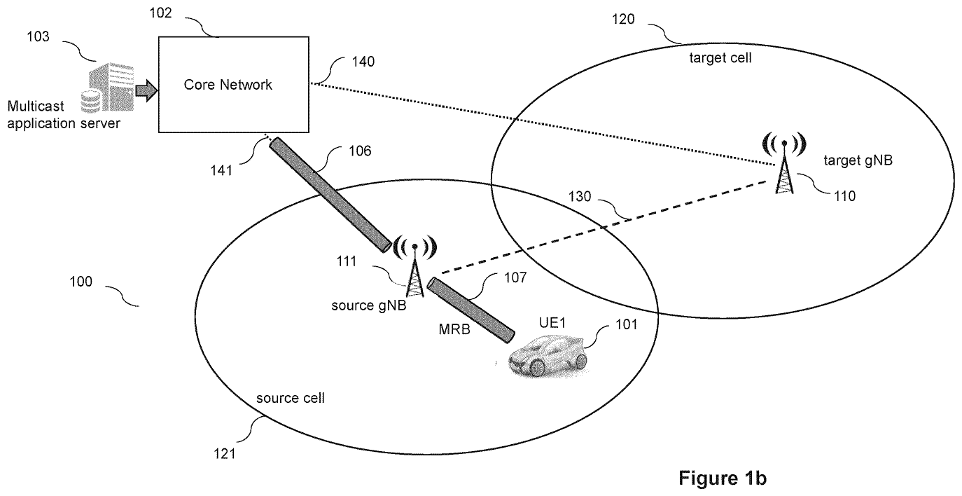

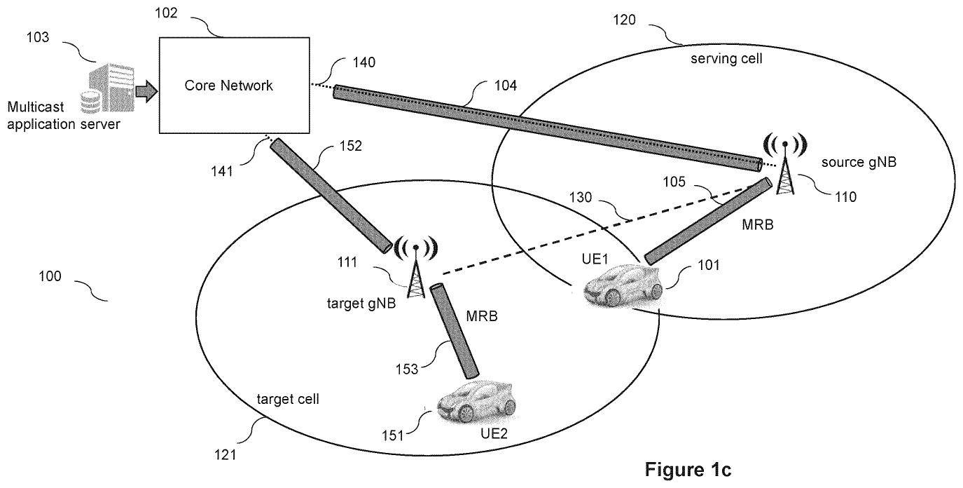

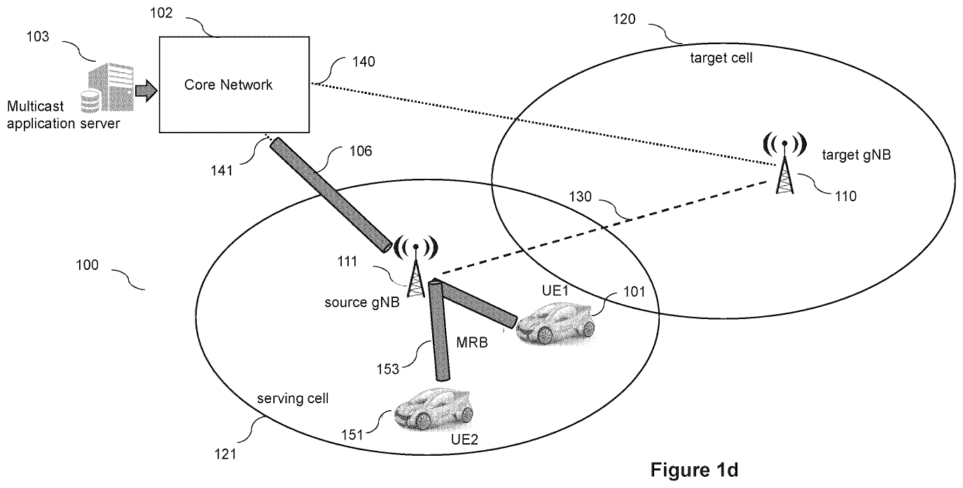

FIG. 1a illustrates an example wireless communication system 100, in particular a mobile radio communication system such as a fifth-generation (5G) New Radio (NR) system supporting multicast and broadcast service (MBS). Although in the following description, embodiments and examples of embodiments of the present invention will be described with respect to a 5G NR system, it will be appreciated that it is not intended that the present invention is limited to 5G NR systems and may be used in any wireless communication systems supporting MBS or similar service.

The system 100 comprises a User Equipment (UE) 101, which may be for instance in or part of a vehicle, served by a base station 110 to communicate with a core network, such as the 5G core network 102. The UE may be any wireless device, such as a wireless communication device or apparatus or terminal, IoT device, Machine Type Communication (MTC) device, Device to Device (D2D) terminal, user device (e.g. smart phone, laptop, mobile phone, tablet, camera, game console, wearable device), capable of wireless communication with one or more core networks via one or more Radio Access Networks. The base station 110 is a network node which provides an access point to the core network for a UE and is part of the Radio Access Network (RAN) composed of the base stations 110, and 111. In NR, base stations are referred to as next-generation Node Bs (gNBs), the RAN is a Next Generation (NG) RAN and the core network is referred to as the 5GC. In the following, the terms RAN node, base station and gNB will be used interchangeably. The base stations 110 and 111 are interconnected by means of the Xn interface (specified in the 3GPP document TS 38.423) implemented on the wired or wireless link 130. Each base station is connected to the core network by means of the NG interface (specified in the 3GPP document TS 38.413) implemented on the wired or wireless links 140 and 141.

Each of these base stations controls one or multiple cells. For instance, the base station 110 controls the cell 120, and the base station 110 controls the cell 121. A cell is a is a geographical area of a radio network defined by the frequency used in the cell to transmit data. The cell can be uniquely identified by a UE from an identification that is broadcasted over a geographical area. Each base station 110, 111 can serve several UEs like the UE 101. Once a UE has established a RRC connection with a base station (as discussed below), the base station, to which the UE is connected, is referred to as the serving base station or source base station of the UE and the cell which is controlled by the serving base station, and on which the UE camps, is referred to as the serving cell. The interface between a gNB and a UE is the Uu interface using the protocol sublayers SDAP (Service Data Application Protocol), PDCP (Packet Data Convergence Protocol), RLC (Radio Link Control), MAC (Medium Access Control), PHY (Physical) in the user plane, and the protocol sublayers RRC (Radio Resource Control), PDCP, RLC, MAC, PHY in the control plane.

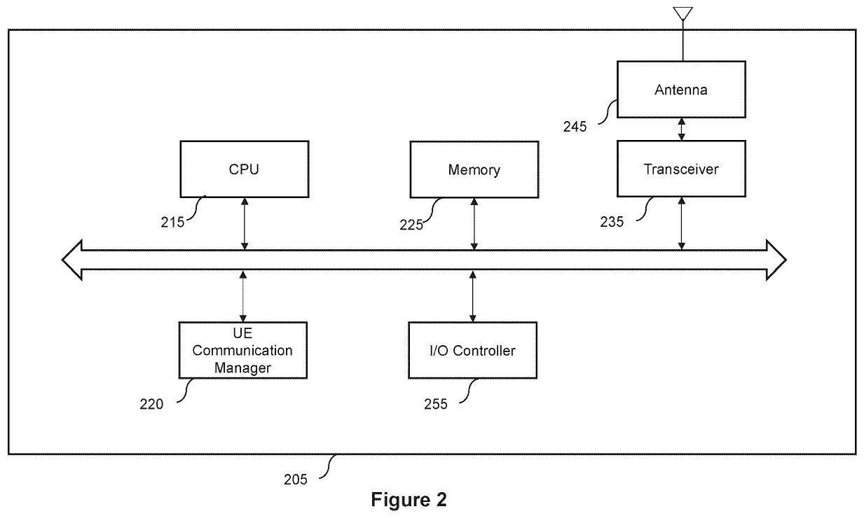

FIG. 2 illustrates a block diagram of a UE device 205, like the UE 101 in the FIG. 1a, in which the present invention may be implemented according to one or more embodiments of the invention. The UE includes components for transmitting and receiving communications, including a UE communication manager 220, a I/O controller 255, a transceiver 235, a set of antennas 245, memory 225, and a processor (CPU: Central Processing Unit) 215. All these elements communicate with each other.

Memory 225 includes RAM (Random Access Memory), ROM (Read Only Memory), or combination of both or as a non-limiting example a mass storage device such as a disk or a Solid-State Drive. Basic Input Output System (BIOS) Instructions may be stored within the memory 225.

The processor 215 is configured to execute machine readable instructions. Execution of these machine-readable instructions causes the UE to perform various functions. These functions may be related to transmission or to interaction with peripheral devices like for instance a keyboard, a screen, a mouse, etc. (not shown in FIG. 2). The processor may run an operating system like for instance, iOS, windows, Android, etc., The processor 215 may be a single processor or may comprise two or more processors carrying out the processing required for the operation of the UE 205. The number of processors and the allocation of processing functions to the processors is a matter of design choice for a skilled person.

The I/O controller 255 allows these interactions with external peripherals by providing the hardware required and by managing input and output signals.

The transceiver 235 is configured to provide bi-directional wireless communication with other wireless devices. For example, it provides the necessary modems and frequency shifters necessary to connect to one or more wireless networks, such as Wi-Fi, Bluetooth, LTE, 5G NR, etc.

The radio communications use the antenna set 245 adapted to the spectrum of the frequency transposed signals, issued from the baseband modems. The antenna set 245 may be limited to one antenna, but preferably it contains several antennas, in order to provide beamforming capability.

UE communication manager 220 handles the communication establishment of the UE to a Radio Access Network, its control and its release. The UE regularly receives from the base station an indication of slots available for communication between the UE and base station. The UE then knows where in time and frequency it expects incoming data or must send its outgoing data, whether they belong to the control or data plane. In an example implementation, the UE communication manager 220 implements the Uu interface.

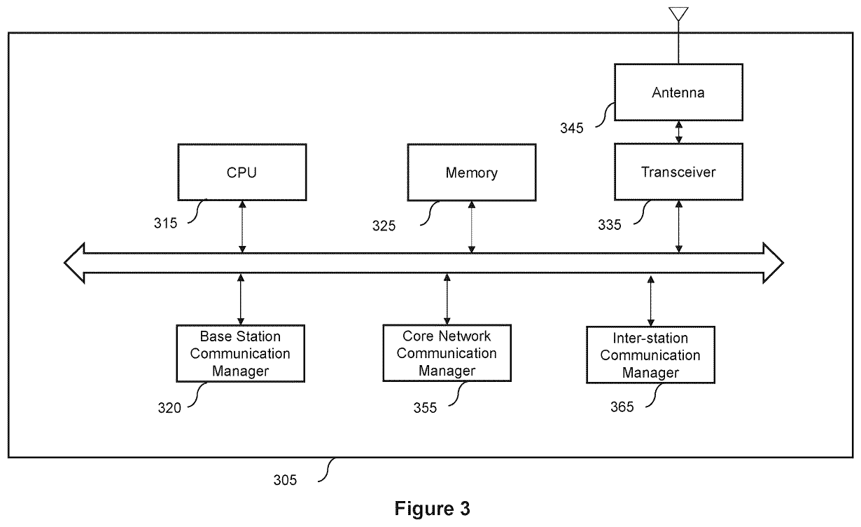

FIG. 3 illustrates a block diagram of a base station device 305, like the base stations or gNBs 110 and 111 in the FIG. 1a, in which the present invention may be implemented according to one or more embodiments of the invention. The base station device 305 includes components for transmitting and receiving communications, including a Base Station communication manager 320, a Core Network communication manager 355, a transceiver 335, a set of antennas 345, memory 325, a processor (CPU) 315, and an Inter-Station communication manager 365. All these elements communicate with each other.

The Base Station communication manager 320 handles the communications with a plurality of UEs. It is responsible for the establishment, the control and the release of these communications. In an example implementation, the Base Station communication manager 320 implements the Uu interface. The Base Station communication manager 320 includes a scheduler that allocates time frequency slots to the different UE communications. Information regarding the schedule of these slots is regularly sent to the involved UEs.

The Core Network communication manager 355 manages communications of the base station with the core network. It may provide a standardized NG interface, as defined by the 3GPP standard, to support these communications.

The transceiver 335 is configured to provide bi-directional wireless communication with other wireless devices. These devices may be UEs, or even other base stations. The transceiver 335 provides the necessary modems and frequency shifters in order to connect to a large number of UEs simultaneously, using different frequency carriers, in Time Division Duplex (TDD) or in Frequency Division Duplex (FDD). The transceiver 335 is connected to the antenna set 345, that may be limited to one antenna, but preferably it contains several antennas, in order to provide beamforming capability.

Memory 325 includes RAM, ROM, or combination of both or as a non-limiting example a mass storage device such as a disk or a Solid-State Drive. BIOS Instructions may be stored within the memory 325 to support an operating system.

The inter-station communication manager 365 manages communications with other base stations. The Inter-Station communication manager 365 may provide a standardized Xn interface, as defined by the 3GPP standard, to support these communications.

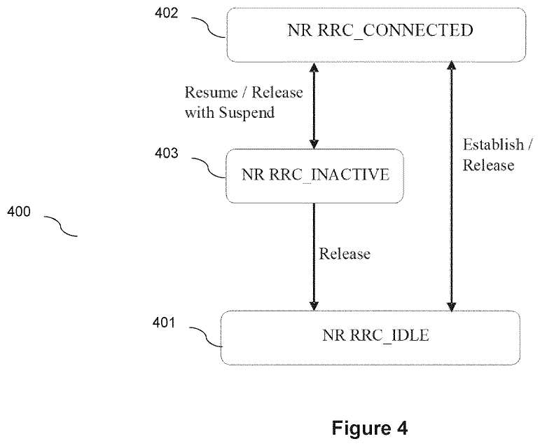

FIG. 4 is a flowchart 400 showing the RRC connection states and transitions for a UE in 5G NR. The RRC protocol operates between a UE and a base station (gNB) and is defined in 3GPP specifications TS 38.331 for 5G NR. The UE's state names are prefixed with “NR” for New Radio. Other prefixes are used for other radio interfaces like LTE radio interface. For the sake of simplicity, the radio technology prefix is omitted in the rest of the description.

Radio Resource Control (RRC) is a layer within the 5G NR protocol stack. It exists only in the control plane, in the UE and in the gNB. The behavior and functions of a base station and a UE are governed by the current RRC state of the UE. In 5G NR, three distinct RRC states are specified for a UE: RRC_IDLE state 401, RRC_CONNECTED state 402 and RRC_INACTIVE state 403.

At power-up the UE is in RRC_IDLE state 401, it performs radio link quality measurements and executes the cell selection evaluation process (as defined in 3GPP specifications TS 38.304) to identify a target gNB to connect to. The UE state changes to RRC_CONNECTED state 402 upon an RRC connection establishment with the target gNB that becomes the source gNB serving the UE. In the following, the source base station (or source gNB) may also be referred to as the serving base station or serving gNB. If there is no radio activity for a while, the RRC connection can be released by the source gNB, then the UE's RRC state changes back to RRC_IDLE state 401.

While releasing an RRC connection is interesting for capacity utilization and power saving, it is not ideal from the latency perspective. The overhead in establishing an RRC connection requires extra signaling that introduces delay. To cope with this drawback, the RRC_INACTIVE state 403 has been introduced for 5G NR. When the UE is in RRC_INNACTIVE state 403, the UE cannot communicate with the 5G system, but both the source gNB (e.g. last serving gNB) and the UE store the UE context or configuration. The stored UE context or configuration includes information to facilitate quick resumption of the connection. The information may include the security context (e.g. security parameters such as security key, UE security capabilities), measurement configuration, radio configuration (e.g. UE radio capability), information about bearers, PDU session context etc. Thus, when in RRC_CONNECTED state 402, the RRC connection can be suspended by the source gNB (Release with suspend), and the UE moves to the RRC_INACTIVE state 403. From the RRC_INACTIVE state 403, the UE can be switched back to the RRC_CONNECTED state 402 by the gNB (Resume) and the UE applies the stored UE context or configuration. The RRC resume message is sent by a gNB upon reception of a RRC resume request message from the UE.

From either the RRC_CONNECTED state or RRC_INNACTIVE state, the UE can transit to RRC_IDLE state upon a RRC release command received from the gNB.

The mobility procedure to migrate a UE from one cell to another depends on the UE's RRC state. In RRC_CONNECTED state, the mobility procedure, called handover, is controlled by the network, and the source gNB takes the decision to trigger the handover procedure based on the measurement reports provided by the UE. In RRC_INACTIVE and in RRC_IDLE states (e.g. non-connected states), the mobility procedure is called cell reselection, and it is managed by the UE itself.

In RRC_INACTIVE state, the UE can be configured by the network with a RAN Notification Area (RNA). For example, the message that transitions the UE to the RRC_INACTIVE state contains information indicating the RNA. The RNA is the area within which the UE can move without notifying the network. When the UE in the RRC_INACTIVE state moves to a cell that is not part of its currently assigned RNA, the UE performs a location-update procedure that enables the RAN (e.g. serving gNB) to update the assigned RNA to the UE. In other words, the UE has the possibility to request an RNA update to be informed of a modification of the RNA. When, as part of the cell reselection process, the UE selects a cell managed by a target gNB out of the RNA, the UE sends a resume request to the target gNB, which has three options available: to keep the UE in RRC_INACTIVE state, to set the UE in RRC_IDLE state, or to set the UE in RRC_CONNECTED state.

In RRC_IDLE state, the paging procedure to inform a UE that it has to resume the connection is initiated by the core network. In RRC_INACTIVE state, the paging procedure is initiated by the NG RAN (i.e. the last gNB that had set the UE in RRC_INACTIVE state).

Back to the FIG. 1a, it is assumed that the UE 101 is in the RRC_INACTIVE state and that it is receiving multicast data of one or more multicast MBS sessions generated by the multicast application server 103. The multicast data are provided to the base station 110, which is the serving base station for UE 101, through the core network 102 and the transport bearer 104 over the link 140. Then, the multicast data are transmitted by the base station 110 to the UE 101 through the MBS Radio Bearer (MRB) 105. A radio bearer is a set of PHY (layer 1) and MAC (layer 2) parameters allowing higher layer data connection between a UE and a gNB. Multiple types of radio bearers are defined in 5G NR: the SRB (Signalling Radio Bearer) for the control plane, the DRB (Data Radio Bearer) allowing point-to-point communication with one UE in the user plane (unicast), and the MRB allowing point-to-point communication and point-to-multipoint communication with multiple UEs (multicast/broadcast), also in the user plane.

The MBS session join procedure, as specified in 3GPP TS 23.247, is used by UEs to inform the 5GC of an interest in joining a multicast MBS session. The first accepted UE join request triggers the multicast MBS session establishment towards the NG RAN and the UE. Before sending a join request for a multicast MBS session, the UE should have established a PDU session that can be associated with multicast session(s), using the procedures as specified in TS 23.502. Also, the UE should know at least the MBS Session ID of a multicast group that the UE can join, via service announcement broadcasted by the network. To join the multicast group, the UE sends a PDU Session Modification Request for the associated PDU session which contains one or several MBS Session ID(s) and a join request. The MBS Session ID(s) indicates the multicast MBS session(s) that UE wants to join.

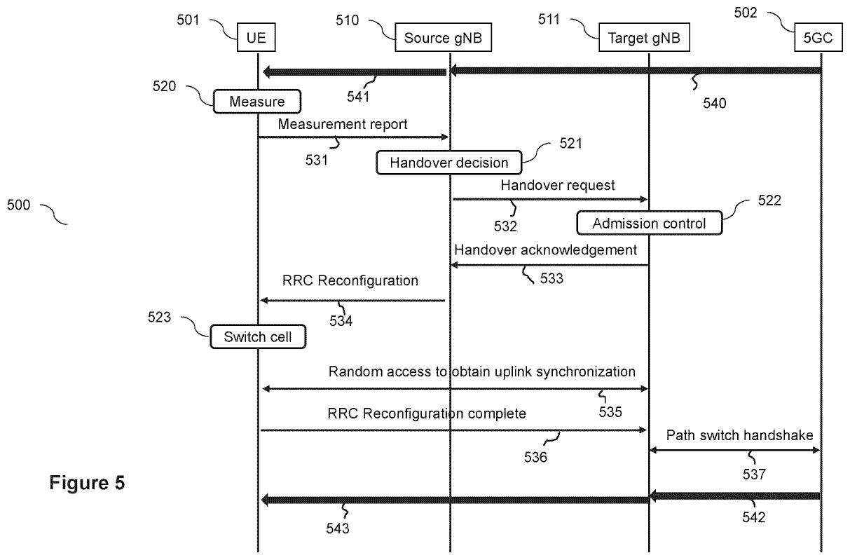

To join an MBS session, the UE has to be in the RRC_CONNECTED state. While receiving MBS multicast data in RRC_CONNECTED state, the UE 101 may have successively moved to different cells using the handover procedure illustrated by FIG. 5.

FIG. 5 is a simplified flowchart 500 illustrating the handover procedure while a UE, such as UE 101 of FIG. 1a, is receiving MBS multicast data in RRC_CONNECTED state. This figure shows a UE 501, like the UE 101, a base station 510, like the base station 110 that is the source or serving gNB in the sense that it controls the cell (which may be referred to as a serving cell) where the UE is currently camping, a base station 511, like the base station 111, controlling a candidate cell where the UE 501 may move, and the core network (5GC) 502, like the core network 102. The MBS multicast data are provided by the 5GC to the source gNB (through the bearer 540), then MBS multicast data are transmitted to the UE 501 (through the radio bearer 541), simultaneously to the other UEs belonging to the same multicast group.

The UE 501 is configured with measurements to perform regularly on cells in the neighborhood. The first step 520, which is continuously executed when in RRC_CONNECTED state, is to search for candidate cells. Once a candidate cell has been found, the UE 501 measures one or more parameters of a signal received from the candidate cell. The parameters may include the reference signal received power (RSRP), or reference signal received quality (RSRQ). For example, the UE 501 measures the reference signal received power (RSRP), or reference signal received quality (RSRQ) typically performed on the Signal Synchronization Block (SSB) transmitted in this candidate cell. Depending on the triggering events configured in the UE, a measurement may trigger a measurement report 531 (RRC protocol message) sent by the UE 501 to the source gNB 510 with information on the candidate cell.

Upon reception of a measurement report 531, the source gNB 510 can decide to perform a handover or not, at the handover decision step 521. Additional information other than the measurement report can be taken into account, such as whether the target gNB controlling the candidate cell or target cell is within the MBS service area and can provide the same MBS service(s) the UE is listening to (e.g. support one or more existing/ongoing MBS session(s) for the UE), and/or whether there is sufficient capacity available in the target cell for the handover. The network may also decide to handover a UE to another cell even if no measurement report has been received, for example for load balancing purposes. If the network decides to handover the UE to another cell, such as the target cell controlled by the target gNB 511 (step 521), the source gNB 510 sends a handover request 532 (Xn protocol message) to the target gNB 511. If the source and target cells belong to the same gNB there is no need for this message as the situation in the target cell is already known by the gNB. The handover request message 532 includes the UE context containing information related to the MBS session(s) the UE has joined. Then, the target gNB 511 performs the admission control step 522 to decide whether to accept or not the handover request. It may reject the request, for instance if the load in the target cell is too high. In any case, the target gNB 511 sends a handover acknowledgment message 533 to the source gNB 510. If the target gNB 511 accepts the handover, the source gNB informs the UE 501 to switch cell through the RRC reconfiguration message 534 containing the necessary information for the UE 501 to connect to the target cell, such as radio bearer(s), measurement configuration, (information previously received by the source gNB from the target gNB in the acknowledgment message 533). In case of conditional handover (CHO), the UE 501 is configured with a triggering condition to fulfil before switching to the new cell (not shown in FIG. 5).

At step 523, the UE 501 switches to the target cell as the new serving cell and moves the RRC connection to the target gNB 511. To be able to connect to the new serving cell, uplink synchronization is required, therefore the UE typically performs random access 535 towards the target cell to acquire uplink synchronization. Once synchronization is established, the UE sends a RRC Reconfiguration Complete message 535 to the target gNB 511, which is now its new source or serving gNB managing the new serving cell.

In the meantime, the target gNB 511 may perform the path switch handshake procedure 537 toward the core network 502 to request the delivery of the MBS multicast data. Thus, the MBS multicast data can be provided by the core network 502 to the target gNB 511 (through the bearer 542), and the MBS multicast data are then transmitted to the UE 101 (through the MBS radio bearer 543), simultaneously to the other UEs belonging to the same multicast group. To minimize or to prevent data loss during the handover operation, any data buffered in the source gNB 510 may be moved to the target gNB 511 (not shown in FIG. 5).

Back again to the FIG. 1a, it is assumed that the UE 101 now camps in the cell 120, which is the serving cell for the UE 101 with the base station 110 as the source or serving gNB, and that without radio activity, apart from the reception of MBS multicast data, the UE 101 has been set in RRC_INACTIVE state by the gNB 110. While the UE 101 is still receiving MBS multicast data, it may move and arrive at the edge of the serving cell 120, but also for instance, at the edge of the other cell 121. At some point, the UE 101 may need to change the serving cell as it may be soon out of coverage of the cell 120. When the UE 101 does need to change its serving cell, unlike the case where the UE is in the RRC_CONNECTED state and the mobility procedure is handled by the network (RAN and core network) to ensure continuity of the delivery of MBS data through the target gNB of the new serving cell, in the RRC_INACTIVE state (and in RRC_IDLE state, both of which are non-connected states), the mobility procedure is called cell reselection which is managed by the UE itself. When performing cell reselection, the UE executes a cell reselection evaluation process (for example, as described in 3GPP specifications TS 38.304 V16.7.0, section 5.2.4) and there is no communication with the network. As there is no communication with the network in the cell reselection procedure, several issues may prevent a UE from continuing to receive the MBS data after cell reselection. For example, when there is no communication with the network in the cell reselection process, the UE is not able to obtain the configuration information required to receive the MBS data via the target gNB and the target gNB is not informed of a new UE in RRC_INACTIVE state wishing to receive an MBS service via the target gNB. Without the configuration information, the UE will not be able to receive the MBS data from the target gNB. Informing the target gNB of a new UE in RRC_INACTIVE state helps to ensure that the UE is authorized to receive the MBS service, and for the target gNB to provide the UE with the configuration information to receive the MBS service in the new cell, and if needed, to request the core network to provide the MBS data to the target gNB.

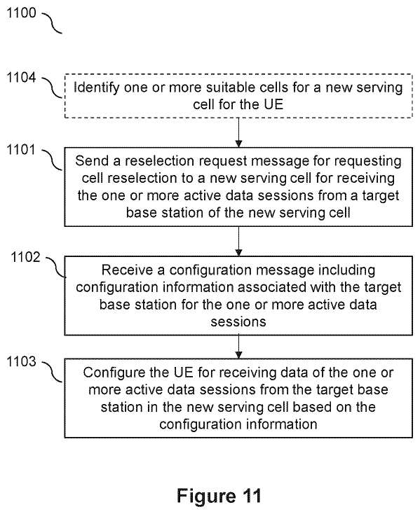

Referring now to FIG. 11 which shows steps of a method 1100 for supporting cell reselection for a UE of a wireless communication system in accordance with embodiments of the present invention, which method is performed by a UE. The wireless communication system may be, for example, the wireless communication system 100 of FIG. 1a and the UE may be the UE 101 of FIG. 1a and may comprise the UE 205 of FIG. 2 with the method 1100 being performed by the processor 215. The UE 101 is operating in a non-connected Radio Resource Control (RRC) state (such as a RRC_INACTIVE state) with one or more active data sessions (such as one or more active MBS session(s)). An active MBS session may be a MBS multicast session or a MBS broadcast session. In other words, the data session is ‘active’ in the sense the UE has joined or is participating in one or more data sessions(s). In the example shown in FIG. 1a, the UE 101 is currently camped on the serving cell 120 (current serving cell) which is controlled by the source base station 110. The UE 101 may move to cell 121. Cell 121 may therefore be referred to as a candidate/target cell which is controlled by a target base station 111. Candidate/target cells may be neighbouring cells to the serving or source cell (i.e. the current serving cell).

Briefly, at step 1101, the UE 101 sends a reselection request message (or notification) for requesting cell reselection to a new serving cell for receiving the one or more active data sessions from a target base station of the new serving cell (e.g. so as to enable the UE to receive data of the one or more active data sessions from the target base station). In the example of FIG. 1a, the new serving call may be cell 121 selected by the UE 101 or the source base station 110 of the current serving cell.

At step 1102, the UE 101 receives a configuration message including configuration information associated with the target base station for the one or more active data sessions. In an example, the configuration information includes radio configuration information indicating the radio configuration of the target base station for the one or more active data sessions. In other words, the UE 101 receives radio configuration information which indicates the radio configuration used by the target base station to transmit data for the one or more active data sessions (e.g. MBS bearer configuration for the one or more active data sessions in the new serving cell). The UE 101 configures itself (e.g. sets up the user plane in the UE 101 according to the radio configuration of the target base station) to receive data of the one or more active data sessions from the target base station in the new serving cell based on the received configuration information, step 1103. The UE 101 may switch to the new serving cell either before or after the reselection request is sent. After the UE 101 is configured and after the UE 101 switches to the new serving cell (which switching may occur either before or after the reselection request is sent), the UE may receive, from the target base station, data for the one or more active data sessions. Steps 1101, 1102 and 1103 are performed by the UE 101 operating in the non-connected RRC state (e.g. the RRC_INACTIVE state).

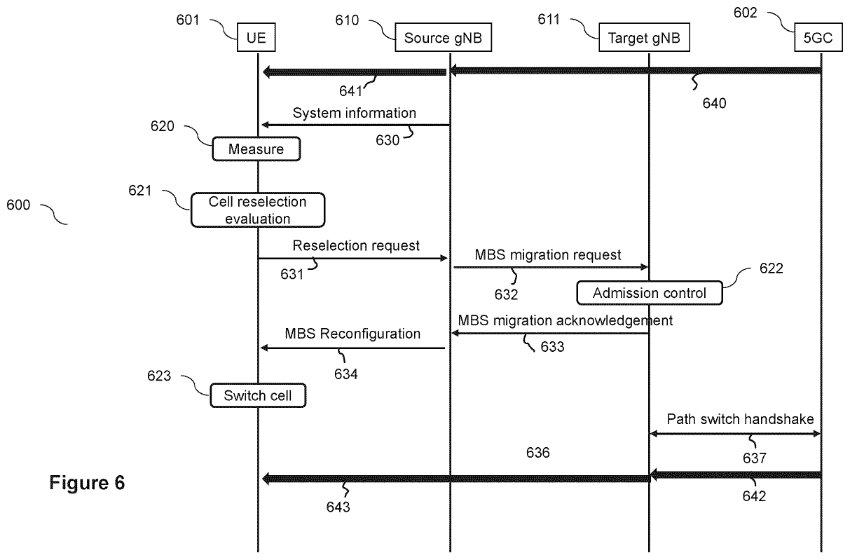

Prior to step 1101, the UE 101 may identify one or more suitable cells for a new serving cell for the UE 101 (step 1104 shown in dotted lines). The new serving cell will be one of the identified one or more suitable cells. For example, the UE 101 may perform measurements on signals received at the UE 101 from one or more candidate cells as discussed below with reference to FIG. 6 (step 620). The UE 101 may select or identify one suitable cell or a list of suitable cells according to cell reselection evaluation criteria, such as the priority of frequencies used in the candidate cells, the radio link quality, the availability of MBS service in the candidate cell, as discussed below (e.g. with reference to FIG. 6). When the UE selects one suitable cell, the UE 101 identifies the one suitable cell selected as a new serving cell in the reselection request message sent by the UE 101. Alternatively, the UE 101 may select a plurality of suitable cells for the new serving cell and thus, may identify a plurality of suitable cells (e.g. as a list of suitable cells) in the reselection request message sent by the UE 101 and the selection of the new serving cell is made after sending the reselection request message (e.g. by the source base station receiving the reselection request message or by the target base station if the target base station controls more than one of the suitable cells). In an example where the target base station selects the new serving cell, the source base station may send a request to the target base station (e.g. in the migration request message as discussed below) with a list of suitable cells for a new serving cell for the UE. The target base station selects one of the suitable cells as the new serving cell (e.g. based on load status in each cell) and in a response to the source base station (e.g. in the migration acknowledgement message as discussed below), the target base station indicates to the source base station the identity of the selected cell (e.g. cell ID) the UE has to switch to.

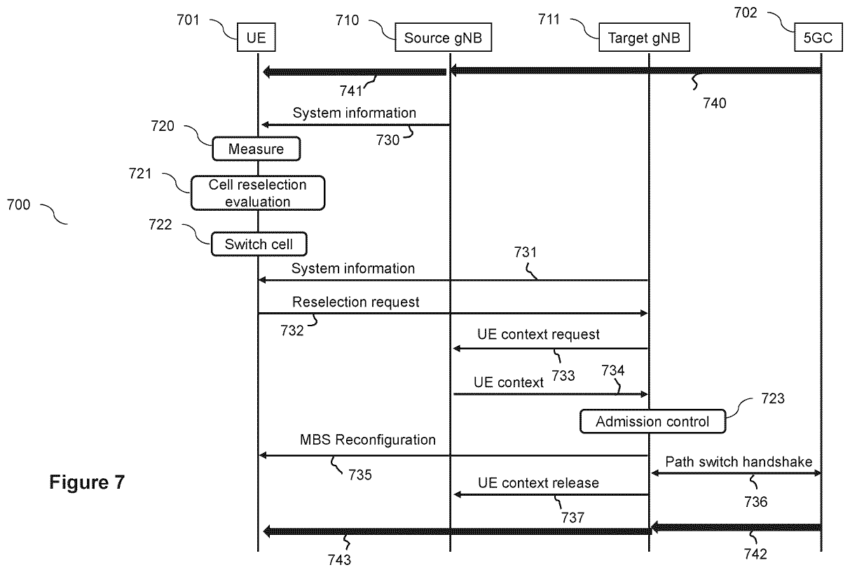

The UE 101 may send the reselection request message to a RAN node such as the source base station 110 of the serving cell or the target base station 111 of the new serving cell. Examples of sending the reselection request message to the source base station 110 of the serving cell are discussed in more detail below with respect to FIGS. 6, 8a, 9a, 10a. Examples of sending the reselection request message to the target base station 111 of the new serving cell are discussed in more detail below with respect to FIGS. 7, 8b, 9b, 10b.

In an example when the UE 101 sends the reselection request message (or notification) to the source base station 110, the UE 101 receives the configuration message from the source base station. The reselection request message may include identification information associated with or identifying one or more suitable cells for the new serving cell. When the reselection request message includes identification information for more than one suitable cell, the source base station 110 selects one of the suitable cells as the new serving cell (or the target base station selects one of the suitable cells when more than one of the suitable cells are controlled by the target base station). Alternatively, the UE 101 may select one suitable cell as the new serving cell for the UE and the reselection request message sent by the UE 101 includes identification information associated with or identifying the one suitable cell selected as the new serving cell. The identification information for the selected cell or each of the suitable cells may include the cell ID and the base station (gNB) ID of the cell. 3GPP TS 38.413 sections 9.3.1.6 and 9.3.1.7 describe the gNB ID being included in the cell ID.

The UE 101 switches to the new serving cell in response to receiving the configuration message from the source base station and can then receive data of the one or more active data sessions from the target base station. When the source base station or the target base station selects one of the suitable cells as the new serving cell, the source base station may include identification information in the configuration message to identify the selected cell (e.g. cell ID) the UE has to switch to.

In an example when the UE 101 sends the reselection request message (or notification) to the target base station 111, the UE 101 receives the configuration message from the target base station. In this case, the UE 101 selects one suitable cell as the new serving cell for the UE 101 according to cell reselection evaluation criteria, such as the priority of frequencies used in the candidate cells, the radio link quality, the availability of MBS service in the candidate cell, as discussed below (e.g. with reference to FIG. 6). The UE 101 then sends the reselection request message to the target base station of the selected new serving cell. The reselection request message sent by the UE 101 includes identification information associated with or identifying the source base station 110 of the serving cell (i.e. the current serving cell). In addition, the reselection request message may include session identification information, such as MBS session identifiers, identifying the one or more active data sessions. In this case, the UE 101 switches to the new serving cell before sending the reselection request message to the target base station 111 (i.e. before the UE 101 has received the configuration information). After receiving the configuration information, the UE 101 can then receive data of the one or more active data sessions from the target base station.

By sending the reselection request message for requesting cell reselection to a new serving cell for receiving the one or more active data sessions from a target base station of the new serving cell, and receiving configuration in response, the UE 101 is able to obtain the configuration information required to receive data of the one or more active data sessions via the target base station which ensures continuity of data service (e.g. MBS service) is maintained or at least data loss is minimised when the UE performs cell reselection and switches to a new serving cell. Furthermore, sending the reselection request message whilst the UE is in a non-connected RRC state means that the UE does not have to be switched to the RRC_CONNECTED state to apply the handover procedure and thus, the benefits of keeping the UE in the non-connected RRC state (e.g. reduced control plane footprint) are maintained.

In the case when the UE 101 sends the reselection request message to the target base station 111, the UE 101 is switched to the new serving cell earlier compared to the case when the UE 101 sends the reselection request message to the source base station 110 and is switched to the new serving cell after receiving configuration information. As the UE 101 is switched earlier to the new serving cell, the data connection with the serving cell is lost earlier. This may result in some data being lost compared to the case where the UE 101 is switched later to the new serving cell after receiving configuration information. However, in the case where there are communication issues with the source base station 110 (e.g. radio link failure), switching to the new serving cell controlled by the target base station 111 early and sending the reselection request message to the target base station 111 means that the UE 101 can receive configuration information associated with the target base station for the one or more active data sessions and configure itself to receive the one or more active data sessions from the target base station with minimal delay and whilst still in a non-connected RRC state which helps to ensure minimal data loss and the continuity of the data service (e.g. the MBS service) without the need to switch to the RRC_CONNECTED state.

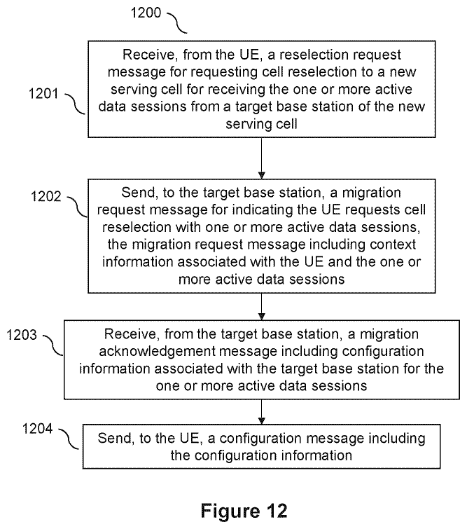

Referring now to FIG. 12 which shows steps of a method 1200 for supporting cell reselection for a UE of a wireless communication system in accordance with embodiments of the present invention, which method is performed by a source base station of a serving cell (e.g. current serving cell) of a UE. The wireless communication system may be, for example, the wireless communication system 100 of FIG. 1a and the source base station may be the source base station 110 supporting a UE 101. The source base station may comprise the base station 305 of FIG. 3 with the method 1200 being performed by the processor 315. The UE 101 is operating in a non-connected Radio Resource Control (RRC) state (such as a RRC_INACTIVE state) with one or more active data sessions (such as one or more active MBS session(s)). An active MBS session may be a MBS multicast session or a MBS broadcast session. In the example shown in FIG. 1a, the UE 101 is currently camped on the serving cell 120 (current serving cell) which is controlled by the source base station 110. The UE 101 may move to cell 121. Cell 121 may therefore be referred to as a candidate/target cell which is controlled by a target base station 111. Candidate/target cells may be neighbouring cells to the serving or source cell (i.e. the current serving cell).

Briefly, at step 1201, the source base station 110 receives, from the UE 101, a reselection request message for requesting cell reselection to a new serving cell for receiving the one or more active data sessions from a target base station of the new serving cell (e.g. so as to enable the UE to receive data of the one or more active data sessions from the target base station). The reselection request message may include identification information associated with or identifying the selected new serving cell (when the UE 101 has selected the new serving cell). Alternatively, the reselection request message may include identification information associated with or identifying the one or more suitable cells selected for the new serving cell. When the reselection request message includes identification information identifying more than one suitable cell for the new serving cell, the source base station 110 may select one of the suitable cells as the new serving cell (or the target base station selects one of the suitable cells when more than one of the suitable cells are controlled by the target base station as discussed below with reference to FIG. 6). The identification information for the selected cell or each of the suitable cells may include the cell ID and the base station (gNB) ID of the cell. 3GPP TS 38.413 sections 9.3.1.6 and 9.3.1.7 describe the gNB ID being included in the cell ID.

At step 1202, the source base station 110 sends, to the target base station 111 of the new serving cell (e.g. cell 121 which has been selected by the UE 101 or by the source base station 110 as the new serving cell), a migration request message for indicating the UE 101 requests cell reselection with one or more active data sessions. The migration request message includes context information associated with the UE and the one or more active data sessions. The context information may include identification information for identifying the UE (e.g. UE ID) and state information for indicating the UE is requesting cell reselection with one or more active data sessions. The context information may further include session identification information (e.g. MBS session identifiers) identifying the one or more active data sessions. The source base station 110 then receives from the target base station 111, at step 1203, a migration acknowledgement message including configuration information associated with the target base station 111 for the one or more active data sessions. The configuration information may include radio configuration information indicating the radio configuration of the target base station (e.g. MBS radio bearer configuration in the new serving cell) for the one or more active data sessions. The migration acknowledgement message may comprise a migration accept message indicating the target base station accepts to be a new serving cell for the UE for the one or more active data sessions, with the migration accept message comprising the configuration information. At step 1204, the source base station 110 sends a configuration message to the UE 101 including the configuration information to enable the UE 101 to receive data (e.g. MBS multicast data) of the one or more active data sessions from the target base station 111. The configuration message sent to the UE 101 informs the UE 101 to switch to the new serving cell. The configuration message may include identification information (e.g. an identifier) identifying the new serving cell to which the UE is to switch. The identification information may include the cell ID and the base station (gNB) ID of the new serving cell. 3GPP TS 38.413 sections 9.3.1.6 and 9.3.1.7 describe the gNB ID being included in the cell ID.

Examples of steps performed at the source base station when receiving a reselection request message from a UE are discussed in more detail below with respect to FIGS. 6, 8a, 9a, 10a.

By communicating with the target base station in response to receiving the reselection request message from the UE, the source base station supports the cell reselection of a new serving cell for the UE and enables the UE 101 to obtain the configuration information required to receive data of the one or more data sessions via the target base station which ensures continuity of data service (e.g. MBS service) is maintained or at least data loss is minimised.

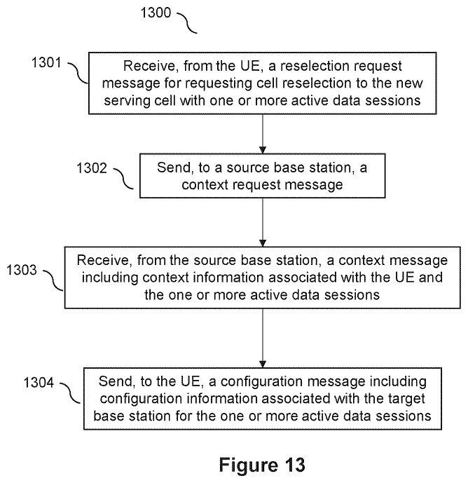

Referring now to FIG. 13 which shows steps of a method 1300 for supporting cell reselection for a UE of a wireless communication system in accordance with embodiments of the present invention. The method 1300 is performed by a target base station of a new serving cell of a UE which has switched from a previous serving cell (e.g. last serving cell) to the new serving cell. The wireless communication system may be, for example, the wireless communication system 100 of FIGS. 1a and 1b and the target base station may be the target base station 111 supporting a UE 101. The target base station may comprise the base station 305 of FIG. 3 with the method 1300 being performed by the processor 315. The UE 101 is operating in a non-connected Radio Resource Control (RRC) state (such as a RRC_INACTIVE state) with one or more active data sessions (such as one or more active MBS session(s)). An active MBS session may be a MBS multicast session or a MBS broadcast session. In the example shown in FIGS. 1a and 1b, the UE 101 was previously camped on the previous serving cell (or last serving cell) 120 controlled by the source base station 110 and has switched to be camped on the new serving cell 121 (e.g. current new serving cell) which is controlled by the target base station 111.

Briefly, at step 1301, the target base station 111 receives, from the UE 101, a reselection request message for requesting cell reselection to the new serving cell 121 with one or more active data sessions. The reselection request message may include identification information identifying the source base station 110 of the previous serving cell 120 (e.g. gNB ID). The reselection request message may further include session identification information identifying the one or more active data sessions (e.g. MBS session identifiers). At step 1302, the target base station 111 sends, to a source base station 110 of the previous serving cell 120, a context request message. The context request message may include identification information for identifying the UE (e.g. UE ID). The context request message may further include information for requesting context information for the one or more active data sessions.

The target base station 111 receives (step 1303), from the source base station 110, a context message including context information associated with the UE and the one or more active data sessions. The context information may include information identifying the one or more active data sessions (e.g. MBS session identifiers).

At step 1304, the target base station 111 sends a configuration message to the UE 101 including configuration information associated with the target base station for the one or more active data sessions to enable the UE 101 to receive data (e.g. MBS multicast data) of the one or more active data sessions from the target base station 111. The configuration information may include radio configuration information indicating the radio configuration of the target base station (e.g. MBS radio bearer configuration in the new serving cell) for the one or more active data sessions. The target base station 111 may also set up the radio resources for delivering data to the UE 101 for the one or more active data sessions.

In an example, the target base station 111, in response to receiving the context message, determines whether to accept or not the cell reselection request for the one or more active data sessions. When the target base station 111 determines it can accept the cell reselection request for the one or more active data sessions (e.g. the target base station has the capacity and ability to support the MBS service for the UE), the target base station 111 sends the configuration message. When the target base station 111 determines it cannot accept the cell reselection request for the one or more active data sessions (e.g. the target base station is overloaded and/or cannot support the MBS service for the UE), the target base station 111 does not send the configuration message including configuration information. The target base station 111 may either send no message in response to the cell reselection request to indicate the cell reselection request for the one or more active data sessions has been rejected or may send a rejection message indicating the cell reselection request has been rejected for the one or more active data sessions.

In an example, in response to receiving the context message, the target base station 111 may communicate with an entity of the core network 102 for establishing (e.g. using a path switch handshake procedure as discussed below (step 736 of FIG. 7)) a Packet Data Unit (PDU) session between the UE 101 and the target base station 111 for the one or more active data sessions. If the target base station 111 is already supporting the one or more active data sessions for one or more other UEs, then the target base station 111 will already be receiving the data for the one or more active data sessions and so there is no need to perform a path switch handshake procedure or similar procedure with the core network entity.

In an example where the UE 101 has switched to be camped on the new serving cell 121 but has identified more than one suitable cell according to cell reselection evaluation criteria (as discussed below), the target base station 111 may receive, from the UE 101, a reselection request message for requesting cell reselection to the new serving cell 121 with one or more active data sessions and the reselection request message may further include identification information identifying more than one suitable cell (e.g. a list of suitable cells). The target base station 111 may then select one of the one or more suitable cells as the new serving cell (e.g. based on load status in each cell) and may send a response to the UE 101 (e.g. in the configuration message) including identification information (e.g. cell ID) indicating the suitable cell that has been selected by the target base station 111. If the selected suitable cell is not the new serving cell 121 on which the UE 101 is currently camped, then the UE 101 will need to switch cells to the selected suitable cell.

Examples of steps performed at the target base station when receiving a reselection request message from a UE are discussed in more detail below with respect to FIGS. 7, 8b, 9b, 10b.

By communicating with the source base station in response to receiving the reselection request message from the UE, the target base station supports the cell reselection of a new serving cell for the UE and enables the UE 101 to obtain the configuration information required to receive data of the one or more active data sessions via the target base station which ensures continuity of data service (e.g. MBS service) is maintained or at least data loss is minimised.

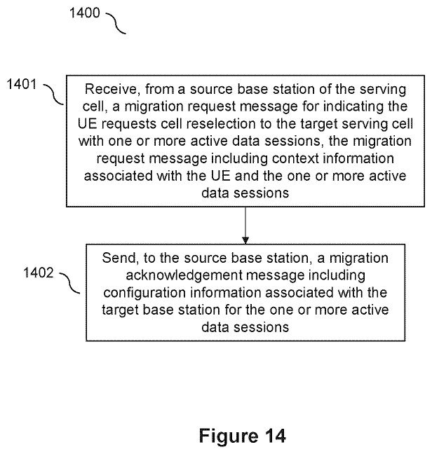

Referring now to FIG. 14 which shows steps of a method 1400 for supporting cell reselection for a UE of a wireless communication system in accordance with embodiments of the present invention. The method 1400 is performed by a target base station controlling a target cell (or target serving cell) which has been selected (by the UE or a source base station of a current serving cell) as a new serving cell for a UE. The wireless communication system may be, for example, the wireless communication system 100 of FIG. 1a and the target base station may be the target base station 111 controlling the target cell 121. The target base station may comprise the base station 305 of FIG. 3 with the method 1400 being performed by the processor 315. The UE 101 is operating in a non-connected Radio Resource Control (RRC) state (such as a RRC_INACTIVE state) with one or more active data sessions (such as one or more active MBS session(s)) via a serving cell (the current serving cell). An active MBS session may be a MBS multicast session or a MBS broadcast session. In the example shown in FIG. 1a, the UE 101 is camped on the serving cell 120 (current serving cell) controlled by the source base station 110. The UE 101 has moved to an edge of serving cell 120 so that it is now also in the coverage of cell 121 (a neighbouring cell to the serving or source cell 120), and cell 121 has been selected (by the source base station 110 or by the UE 101) as the new serving cell but the UE 101 has not yet switched to the new serving cell.

Briefly, at step 1401, the target base station 111 receives, from the source base station 110 of the serving cell 120, a migration request message for indicating the UE requests cell reselection from the serving cell 120 to the target cell 121 (which is the new serving cell) with one or more active data sessions. The migration request message includes context information associated with the UE and the one or more active data sessions. The context information may include session identification information identifying the one or more active data sessions (e.g. MBS session identifiers). At step 1402, the target base station 111 sends a migration acknowledgement message to the source base station 110 including configuration information associated with the target base station for the one or more active data sessions to enable the UE 101 to receive data (e.g. MBS multicast data) of the one or more active data sessions from the target base station 111. The configuration information may include radio configuration information indicating the radio configuration of the target base station (e.g. MBS radio bearer configuration in the new serving cell) for the one or more active data sessions. The target base station 111 may also set up the radio resources for delivering data to the UE 101 for the one or more active data sessions.

In an example, the target base station 111, in response to receiving the migration request message, determines whether to accept or not the cell reselection request for the one or more active data sessions. When the target base station 111 determines it can accept the cell reselection request for the one or more active data sessions (e.g. the target base station has the capacity and ability to support the MBS service for the UE), the target base station 111 sends the migration acknowledgement message (e.g. a migration accept message) including the configuration information. When the target base station 111 determines it cannot accept the cell reselection request for the one or more active data sessions (e.g. the target base station is overloaded and/or cannot support the MBS service for the UE), the target base station 111 may either send no message in response to the migration request message to indicate the cell reselection request for the one or more active data sessions has been rejected or may send the migration acknowledgement message (e.g. a migration rejection message) indicating the cell reselection request has been rejected for the one or more active data sessions.

In the case where the UE 101 has selected a plurality of suitable cells for the new serving cell and has identified the selected plurality of suitable cells (e.g. as a list of suitable cells) in the reselection request message sent by the UE 101 to the source base station 110, the target base station 111 may receive from the source base station 110 a request (e.g. included in the migration request message) with a list of the suitable cells for a new serving cell for the UE. The target base station 111 then selects one of the suitable cells as the new serving cell (e.g. based on load status in each cell) and sends a response to the source base station 110 (e.g. included in the migration acknowledgement message) which indicates to the source base station 110 the identity of the selected cell (e.g. cell ID) to which the UE will need to switch.

Examples of steps performed at the target base station when receiving a migration request message from a source base station are discussed in more detail below with respect to FIGS. 6, 8a, 9a, 10a.

By communicating with the source base station in response to receiving the migration request message from the source base station, the target base station supports the cell reselection of a new serving cell for the UE and enables the UE 101 to obtain the configuration information required to receive data of the one or more data sessions via the target base station which ensures continuity of data service (e.g. MBS service) is maintained or at least data loss is minimised.

Examples of cell reselection procedures according to embodiments of the invention will now be described in more detail with reference to FIGS. 6 and 7 and FIGS. 8a, 8b, 9a, 9b, 10a, 10b.

FIG. 6 is a flowchart 600 illustrating a first example of a cell reselection procedure for a UE in RRC_INACTIVE state and receiving MBS multicast data according to embodiments of the invention. The UE may be in a RRC_INACTIVE state with one or more active data sessions: i.e. the UE is participating in or has joined one or more data sessions (such as one or more MBS sessions). The following description refers to one or more active MBS multicast sessions. Alternatively, the MBS session may be a MBS broadcast session.

This figure shows a UE 601, like the UE 101 of FIG. 1a, in RRC_INACTIVE state, a base station 610, like the base station 110, that is the source or serving gNB in the sense that it controls the cell (i.e. serving cell) where the UE 601 is currently camping, a base station 611, like the base station 111, controlling a target cell (which may also be referred to as a candidate cell) where the UE 601 may move (the base station controlling the target cell may be referred to as the target base station), and the core network (5GC) 602, like the core network 102. The MBS multicast data are provided by the 5GC to the source gNB (through the bearer 640), then they are transmitted to the UE 601 (through the MBS radio bearer 641), simultaneously to the other UEs belonging to the same multicast group.

As for the step 520 in the handover procedure (described above with reference to FIG. 5), the UE 601 regularly performs measurement (step 620) on signals received at the UE 601 from the serving cell and one or more candidate cells, such as the Signal Synchronization Block (SSB) transmitted in the serving cell and in the candidate cells (also called target cells). The candidate cells may be neighbouring cells to the serving or source cell (i.e. the current serving cell).

Once the UE 601 discovers at least one SSB with a received power that exceeds the received power of its current SSB by a certain threshold, it executes a cell reselection evaluation process at step 621. The cell reselection evaluation process is performed according to several criteria that may include: the priority of frequencies used in the candidate cells, the radio link quality, the availability of MBS service in the candidate cell. The input information for the selection (priority frequencies, MBS availability) may be provided by the source gNB 610 through the system information message 630. The measurements in step 620 provide radio link quality information for the selection. Details of an example cell reselection evaluation process performed by the UE are given in 3GPP TS 38.304 (V16.7.0), section 5.2.4.

System information is a name for all the common (non-device-specific) information that a UE needs in order to properly operate within the network. In general, the system information is carried within different System Information Blocks (SIBs), each comprising different types of system information. The various SIBs are specified in the 3GPP document TS 38.331. Delivering the SIBs is done in different ways depending on whether the UE is connected to the network or not: if the device is connected to the network, a dedicated RRC signaling is used, otherwise broadcast signaling is used. Among the different SIBs, SIB1 comprises the system information that a device needs to know before it can access the system (i.e. for the initial random access). SIB1 is always periodically broadcasted, and also includes information about the mapping of the remaining SIBs to system information messages, information about the transmission periodicity of each SIB and whether or not it is broadcasted. Indeed, SIBs can be periodically broadcasted as SIB1, but alternatively, these SIBs can be transmitted on demand, avoiding periodic broadcast in cells where no device is currently camping (and thus saving power). In this case, a UE has to explicitly request some SIBs transmission by means of a system information request message. When in RRC_INACTIVE state, the UE may transmit such request message through the random-access procedure. See, for example, the description of a Random Access Procedure in section 9.2.6 of 3GPP TS 38.300 (V16.8.0) and section 5.1 of 3GPP TS 38.321 (V16.7.0).

Based on the received system information 630 and on the measurement performed at step 620, the UE 601 may select a suitable cell to move to as a new serving cell for the UE, at step 621 (cell reselection evaluation process). At step 621, the UE 601 may identify one suitable cell or a list of suitable cells according to cell reselection evaluation criteria, such as the priority of frequencies used in the candidate cells, the radio link quality, the availability of MBS service in the candidate cell, as discussed above. When the UE 601 identifies a plurality of suitable cells, the source gNB 610 may select one of the suitable cells as a new serving cell (or the target gNB 611 may perform the selection). Taking the example of the FIG. 1a, the UE 101 identifies the target cell 121 (target cell 611) as a suitable cell to camp on.

Then, the UE 601 sends a reselection request message 631 to the source gNB 610 (which is the base station controlling the serving cell (i.e. the current serving cell)) indicating the identifier(s) of the suitable cell(s) selected at step 621. The reselection request message sent by the UE 601 is for requesting cell reselection to a new serving cell for receiving the one or more active data sessions from a target base station of the new serving cell: the new serving cell may be selected by the UE 601 prior to sending the reselection request message (and the reselection request message includes information identifying the selected new serving cell) or may be selected by the source gNB 610 based on information (identifying information for identifying a plurality of suitable cells for the new serving cell for the UE) included in the reselection request message.

According to an example, the reselection request message 631 may be the RRCResumeRequest message or the RRCResumeRequest1 message specified in the 3GPP document TS 38.331 (v16.7.0), amended to include information indicating that the intention of the UE is not to switch to RRC_CONNECTED state but to perform cell reselection. For this purpose, the resumeCause Information Element (IE) may be set to a new value indicating the cause is cell reselection. Besides, a new IE may also be introduced to indicate the suitable cell(s) identifier(s) selected at the step 621. For example, a new IE may be introduced to the RRCResumeRequest message or the RRCResumeRequest1 message to include identification information for identifying one or more suitable cell(s). The identification information for identifying each of one or more suitable cell(s) may include the cell ID and the base station (gNB) ID of the cell. 3GPP TS 38.413 sections 9.3.1.6 and 9.3.1.7 describes the gNB ID being included in the cell ID.

Upon reception of the reselection request message 631, the source gNB 610 uses the cell(s) identifier(s) to determine the associated target gNB(s). In a case where the UE 601 provided several cell identifiers for several suitable cells, the source gNB has to select one target gNB according to predefined or certain criteria. For instance, the source gNB 610 may select the target gNB 611 providing the MBS service with the lowest load. Otherwise, the cell identifier provided in the reselection request message 631 may be the cell identifier of a suitable cell selected by the UE 601 as a new serving cell and the source gNB 610 uses the cell identifier of the selected cell to determine the associated gNB which is the target gNB 611.

Then, the source gNB initiates a procedure similar to the handover procedure described above with reference to FIG. 5 (e.g. similar to the steps 521, 522, 533, 534 of FIG. 5). The source gNB 610 sends an MBS migration request message 632 to the target gNB 611. If the source and target cells belong to the same gNB, there is no need for this message as the situation in the target cell is already known by the gNB. The MBS migration request message 632 includes the UE context containing information related to the MBS session(s) the UE has joined. The MBS migration request message 632 indicates the UE is requesting cell reselection to the target cell with one or more active data sessions (i.e. the UE is participating in or has joined one or more MBS sessions) and may include context information associated with the UE and the one or more active MBS sessions. In an example, the context information includes identification information for identifying the UE and state information for indicating the UE is requesting cell reselection with one or more active MBS sessions. The context information may also include information relating to the one or more active MBS sessions, such as the MBS session IDs. The state information may include information indicating the UE is operating in a non-connected state (e.g. RRC_INACTIVE state) in addition to or as an alternative to indicating the UE is requesting cell reselection.

According to an example, the MBS migration request message 632 may be the HANDOVER REQUEST message specified in the 3GPP document TS 38.423 (v16.8.0), amended to include information indicating that the intention of the UE is to perform cell reselection while receiving MBS multicast data (e.g. whilst participating in or having joined one or more MBS sessions). For this purpose, the Cause IE of the HANDOVER REQUEST message may be set to a new value indicating a cell reselection with an active MBS session.

Then, the target gNB 611 performs an admission control process (step 622) to decide whether to accept or not the MBS migration request. It may reject the request, for instance if the load in the target cell is too high. In any case, the target gNB 611 sends an MBS migration acknowledgment message 633 to the source gNB 610. According to one example, if the target gNB 611 accepts the request, the MBS migration acknowledgment message 633 may be the HANDOVER REQUEST ACKNOWLEDGE message specified in the 3GPP document TS 38.423 (v16.8.0), including the necessary information for the UE 601 to receive the MBS multicast data in the target cell (i.e. the MBS radio bearer configuration in the target cell). In other words, when the target gNB 611 accepts the request, the target gNB 611 sends a migration accept message (e.g. HANDOVER REQUEST ACKNOWLEDGE message) as the MBS migration acknowledgment message 633. The migration accept message includes configuration information associated with the target gNB 611 for the one or more active MBS sessions to enable the UE to be properly configured to receive the MBS data from the target gNB 611 in the target cell. According to another example, if the target gNB 611 rejects the request, the MBS migration acknowledgment message 633 may be the HANDOVER PREPARATION FAILURE message specified in the 3GPP document TS 38.423 (v16.8.0), with the Cause IE set to the appropriate value to indicate the cause of the rejection. In other words, when the target gNB 611 rejects the request, the target gNB 611 sends a migration reject message as the MBS migration acknowledgment message 633.

In the case where the UE 601 has selected a plurality of suitable cells for the new serving cell and has identified the selected plurality of suitable cells (e.g. as a list of suitable cells) in the reselection request message 631 sent by the UE 601 to the source gNB 110, the source gNB 610 may send to the target gNB 611 a request (e.g. included in the migration request message 632) with a list of the suitable cells for a new serving cell for the UE 601. The target gNB 611 then selects one of the suitable cells as the new serving cell (e.g. based on load status in each cell) and sends a response to the source gNB 610 (e.g. included in the migration acknowledgement message 633 or migration accept message) which indicates to the source gNB 610 the identity of the selected cell (e.g. cell ID).

If the target gNB 611 has accepted the MBS migration request, the source gNB 610 informs the UE 601 to switch cell through a configuration message, such as the MBS reconfiguration message 634, containing the necessary information for the UE 601 to receive the MBS multicast data in the target cell (information previously received by the source gNB from the target gNB in the MBS acknowledgment message 633). The necessary information includes configuration information (e.g. the configuration information received from the target gNB 611 in the migration accept message) that enables the UE to configure itself to receive MBS data from the target gNB for the one or more active MBS sessions in the target or serving cell. The configuration information may comprise radio configuration information indicating the radio configuration of the target gNB for the one or more active MBS sessions (i.e. the radio configuration set up for the target gNB to transmit MBS data for the one or more active MBS sessions). The radio configuration information may include information relating to the MBS radio bearer configuration, used by the target gNB for the one or more active MBS sessions. The message 634 may include the identifier of the target cell to which the UE 601 is to switch. For example, in the case when the source gNB 610 selects the target cell or in the case where the target gNB 611 selects the target cell.

According to an example, the MBS reconfiguration message 634 may be the RRCReconfiguration message specified in the 3GPP document TS 38.331 (v16.7.0) amended to allow this message to be sent to a UE in RRC_INACTIVE state. The MBS radio bearer configuration may be included in the RadioBearerConfig IE specified in TS38.331 section 6.3.2. According to another example, the MBS reconfiguration message 634 may be the RRCRelease message or the RRCRelease with suspend configuration message, specified in the 3GPP document TS 38.331 (v16.7.0). According to another example, the MBS reconfiguration message 634 may be a dedicated SIB message.

If the target gNB 611 has rejected the reselection request, the source gNB 610 may inform the UE 601 of the decision. According to an example, the message 634 may also be the RRCReconfiguration message, the RRCRelease message, the RRCRelease with suspend configuration message, or a SIB. According to another example, the non-reception of the message 634 in the UE 601 at the expiration of a timer initialized at the transmission of the reselection request message 631, may indicate that the reselection request is rejected.

At step 623, the UE 601 switches to the new serving cell controlled by the target gNB 611, and configures its user plane to receive the MBS multicast data from the target gNB 611. For example, the UE 601 configures itself based on the received configuration information to receive MBS data from the target gNB 611 for the one or more active MBS sessions. In the meantime, the target gNB 611 may perform the path switch handshake procedure 637 toward the core network 602 to request the delivery of the MBS multicast data. The path switch handshake procedure is described in 3GPP TS 38.413 v16.8.0 section 8.4.4. For example, the target gNB 611 may communicate with the core network 602 to establish or set up a Packet Data Unit, PDU, session between the UE 601 and the target base station 611 for the one or more MBS sessions. The procedure 637 may not be required if the target gNB 611 is already providing the MBS service(s) to other UEs and thus, is already receiving the MBS multicast data from the core network 602. Thus, the MBS multicast data are provided by the core network 602 to the target gNB 611 (through the bearer 642), and then the MBS multicast data are transmitted to the UE 601 (through the MBS radio bearer 643), simultaneously to the other UEs belonging to the same multicast group. To minimize or to prevent data loss during the MBS traffic migration, any data buffered in the source gNB 610 may be moved to the target gNB 611 and then transmitted to the UE 601 (this step is not shown in FIG. 6).

The case where the target gNB 611 was not already providing the MBS service before the path switch handshake procedure 637, corresponds to the situation shown in FIG. 1a. At the end of the cell reselection procedure of FIG. 6, the resulting situation is depicted with FIG. 1b where the UE 101 has switched to the new serving cell 121 controlled by the target gNB 111, and has configured its user plane to receive the MBS multicast data from the target gNB 111.

The case where the target gNB 611 of FIG. 6 was already providing the MBS service when the UE 601 switches cell at step 623 is illustrated by the FIGS. 1c and 1d.

FIG. 1b illustrates the result of the application by the UE 101 of the cell reselection procedure described with reference to FIG. 6 or the cell reselection procedure described below with reference to FIG. 7 (or FIG. 11). It represents the same wireless communication system 100 as shown in the FIG. 1a (the same entities in FIG. 1b are referenced by the same reference numerals as used in FIG. 1a), but now the UE 101 has switched to the serving cell 121 controlled by the base station 111, which is the new source gNB or serving gNB for the UE 101.

The MBS multicast data are provided from the multicast application server 103 to the base station 111 through the core network 102 and the transport bearer 106 over the link 141. Then, the MBS multicast data are transmitted by the base station 111 to the UE 101 through the MBS Radio Bearer (MRB) 107.

The base station 110 and the cell 120 can now be considered as a candidate/target gNB and target cell from the UE's 101 point of view. In case the UE 101 was the only UE receiving the MBS multicast service in the cell 120, the base station 110 may have released the radio resource associated with the MBS radio bearer 105. Thus, the core network 102 is no longer providing to the base station 110 the MBS multicast data associated to the MBS service the UE 101 was listening to. As a consequence, the transport bearer 104 has been released.

FIG. 1c represents the same wireless communication system 100 as shown in the FIG. 1a (the same entities in FIG. 1c are referenced by the same reference numerals as used in FIG. 1a), but in addition there is another UE 151 camping on the cell 121 and receiving the same MBS multicast service as the UE 101 which is camped on the cell 120 controlled by the gNB 110. The MBS multicast data are provided to the base station 111 through the core network 102 and the transport bearer 152 over the link 141. Then, the MBS multicast data are transmitted by the base station 111 to the UE 151 through the MBS Radio Bearer (MRB) 153. The UE 151 may be in RRC_CONNECTED state or in RRC_INACTIVE state.

FIG. 1d illustrates the result of the application by the UE 101 of the cell reselection procedure described at the FIG. 6 or at the FIG. 7 (or FIG. 11). It represents the same wireless communication system 100 as shown in the FIG. 1c (the same entities in FIG. 1d are referenced by the same reference numerals as used in FIG. 1c), but now the UE 101 has switched to the serving cell 121 controlled by the base station 111, which is the new source gNB for the UE 101.

The MBS multicast data are still provided to the base station 111 through the core network 102 and the transport bearer 106 over the link 141. Then, they are transmitted by the base station 111 to the UE 101 and the UE 151 through the same MBS Radio Bearer (MRB) 153 (point-to-multipoint transmission).

The base station 110 and the cell 120 can now be considered as candidate/target gNB and target cell from the UE's 101 and the UE's 151 point of view. In case the UE 101 was the only UE receiving the MBS multicast service in the cell 120, the base station 110 may have released the radio resource associated with the MBS radio bearer 105. Thus, the core network 102 is no longer providing to the base station 110 the MBS multicast data associated to the MBS service the UE 101 was listening to. As a consequence, the transport bearer 104 has been released.

FIG. 7 is a flowchart 700 illustrating a second example of a cell reselection procedure for a UE in RRC_INACTIVE state and receiving MBS multicast data according to embodiments of the invention. The UE may be in a RRC_INACTIVE state with one or more active data sessions: i.e. the UE is participating in or has joined one or more data sessions (such as one or more MBS sessions). The following description refers to one or more active MBS multicast sessions. Alternatively, the MBS session may be a MBS broadcast session. This procedure is intended to cover the case the UE has lost the connection with the source gNB prior to the completion of a cell reselection procedure as described with reference to FIG. 6. In other words, the UE has switched to the target gNB before the completion of a cell reselection procedure, such as that described with respect to FIG. 6.

The FIG. 7 shows a UE 701, like the UE 101 of FIG. 1a, in RRC_INACTIVE state, a base station 710, like the base station 110, that is the source or serving gNB in the sense that it controls the cell (i.e. serving cell) where the UE 701 is currently camping, a base station 711, like the base station 111, controlling a target cell (which may also be referred to as a candidate cell) where the UE 701 may move, and the core network (5GC) 702 like the core network 102. The MBS multicast data are provided by the 5GC to the source gNB (through the bearer 740), then they are transmitted to the UE 701 (through the MBS radio bearer 741), simultaneously to the other UEs belonging to the same multicast group.

As for the step 520 in the handover procedure (described above with reference to FIG. 5), the UE 701 regularly performs measurement (step 720) on signals received at the UE 701 from the serving cell and one or more candidate cells, such as the Signal Synchronization Block (SSB) transmitted in the serving cell and in the candidate cells (also called target cells). The candidate cells may be neighbouring cells to the serving or source cell (i.e. the current serving cell). Once the UE 701 discovers at least one SSB with a received power that exceeds the received power of its current SSB by a certain threshold, it executes a cell reselection evaluation process at step 721. The cell reselection evaluation process is performed according to several criteria that may include: the priority of frequencies used in the candidate cells, the radio link quality, the availability of MBS service in the candidate cell. The input information for the selection (priority frequencies, MBS availability) may be provided by the source gNB 710 through the system information message 730. The measurements in step 720 provide radio link quality information for the selection. Details of an example cell reselection evaluation process performed by the UE are given in 3GPP TS 38.304 (V16.7.0), section 5.2.4.

In some situations, the UE 101 may become out of coverage of the source gNB 710. This may be due to a degradation of the radio conditions leading to a radio link failure. Based on the received system information 730 and on the measurement performed at step 720, the UE 701 selects one suitable cell as a new serving cell at step 721, and effectively switches to this cell at step 722. For example, at step 721, the UE 701 may identify one suitable cell or a list of suitable cells according to criteria, such as the priority of frequencies used in the candidate cells, the radio link quality, the availability of MBS service in the candidate cell, as discussed above. Once a suitable cell has been selected by the UE 701 as the new serving cell, the UE 701 switches to this cell (step 722). Taking the example of the FIG. 1a, the UE 101 identifies the target cell 121 as a suitable cell to camp on and switches to this cell 121 as the new serving cell.

The UE 701 receives the system information 731 broadcasted by the target gNB 711 and although this system information 731 helps the UE 701 to switch to the target cell 121 as the new serving cell, the broadcasted system information is not sufficient to enable the UE 701 to receive the MBS multicast data the target gNB may be providing to other UEs. Therefore, the UE 701 triggers the random-access process and sends a reselection request 732 to the target gNB 711. The reselection request message sent by the UE 701 is for requesting cell reselection to the target cell 121 as the new serving cell for receiving the one or more active data sessions from a target base station of the new serving cell (e.g. so as to enable the UE 701 to receive data of the one or more active MBS sessions from the target base station (e.g. gNB 711)). According to an example, the reselection request message 732 may be the RRCResumeRequest message or the RRCResumeRequest1 message specified in the 3GPP document TS 38.331 (v16.7.0), amended to include information indicating that the intention of the UE is not to switch to RRC_CONNECTED state and it is not to perform an RNA update, but to perform cell reselection with MBS multicast data to receive. For this purpose, the resumeCause IE may be set to a new value indicating the cause is cell reselection. Besides, a new IE may also be introduced to indicate the MBS session ID(s) of the one or more active MBS sessions the UE is listening to. The message 732 includes an identifier allowing the target gNB 711 to identify the source gNB 710. In other words, the reselection request message may include identification information (e.g. gNB ID or cell ID) for identifying the base station 710 (source or serving gNB 710) of the serving cell (i.e. the previous serving cell which is the last serving cell from which the UE is switched to the target cell 121 as the new serving cell).

Then, the target gNB 711 sends a UE context request message 733 to the source gNB 710 to retrieve the information related to the UE 701 (e.g. the context request message 733 is a request for context information). The context request message 733 may include identification information for identifying the UE 701 (such as UE ID). The context request message may further include information for requesting context information for the one or more active data sessions. In response, the source gNB 710 sends a UE context message 734 that may include information identifying the one or more active MBS sessions (e.g. the UE context message 734 may include the identifier(s) of the MBS session(s) the UE 701 is listening to). According to one example, the UE context request message 733 may be the RETRIEVE UE CONTEXT REQUEST message specified in the 3GPP document TS 38.423 (v16.8.0), and UE context message 734 may be the RETRIEVE UE CONTEXT RESPONSE message specified in the same 3GPP document.

Then, the target gNB 711 performs the admission control step 723 to decide whether to accept or not the cell reselection request. It may reject the request, for instance if the load in the target cell is too high. Also, it may accept the admission of the UE 701 but it may reject the delivery of the MBS multicast service. If the request to deliver the MBS multicast service is accepted, the target gNB 711 sends to the UE 701 an MBS reconfiguration message 735 containing the necessary information for the UE 701 to receive the MBS multicast data in the target cell (i.e. the MBS radio bearer configuration in the target cell). In other words, when the target gNB 711 accepts the cell reselection request and to deliver the MBS service, the target gNB 711 sends, to the UE 701, a configuration message 735 which includes configuration information associated with the target gNB 711 for the one or more active MBS sessions to enable the UE to be properly configured to receive the MBS data from the target gNB 711 for the one or more active MBS sessions in the target cell. The configuration information may comprise radio configuration information indicating the radio configuration of the target gNB for the one or more active MBS sessions (i.e. the radio configuration set up for the target gNB to transmit MBS data for the one or more active MBS sessions). The radio configuration information may include information relating to the MBS radio bearer configuration used by the target gNB for the one or more active MBS sessions, etc., The UE 701 may then configure itself (e.g. its user plane) based on the received configuration information to receive MBS data from the target gNB 711 for the one or more active MBS sessions.

In an example where the UE 701 has switched to be camped on the new serving cell 121 but has identified more than one suitable cell according to cell reselection evaluation criteria (as discussed below), the target gNB 711 may receive, from the UE 701, a reselection request message for requesting cell reselection to the new serving cell with one or more active data sessions and the reselection request message may further include identification information identifying more than one suitable cell (e.g. a list of suitable cells). The target gNB 711 may then select one of the one or more suitable cells as the new serving cell (e.g. based on load status in each cell) and may send a response to the UE 701 (e.g. in the configuration message 735) including identification information (e.g. cell ID) indicating the suitable cell that has been selected by the target gNB 711. If the selected suitable cell is not the new serving cell on which the UE 701 is currently camped, then the UE 701 will need to switch cells to the selected suitable cell.

According to an example, the MBS reconfiguration message 735 may be the RRCReconfiguration message specified in the 3GPP document TS 38.331 (v16.7.0) amended to allow this message to be sent to a UE in RRC_INACTIVE state. According to another example, the MBS reconfiguration message 735 may be the RRCRelease message or the RRCRelease with suspend configuration message, specified in the 3GPP document TS 38.331 (v16.7.0). According to another example, the message 735 may be a dedicated SIB message. According to another example, the non-reception of the message 735 in the UE 701 at the expiration of a timer initialized at the transmission of the reselection request message 732, may indicate that the reselection request is rejected.

In the meantime, the target gNB 711 may perform the path switch handshake procedure 736 toward the core network 702 to request the delivery of MBS multicast data. For example, the target gNB 711 may communicate with the core network 702 to establish or set up a Packet Data Unit, PDU, session between the UE 701 and the target base station 711 for the one or more MBS sessions. The procedure 736 may not be required if the target gNB 711 is already providing the MBS service(s) to other UEs and thus, is already receiving the MBS multicast data from the core network 702. Thus, the MBS multicast data are provided by the core network 702 to the target gNB 711 (through the bearer 742), and then the MBS multicast data are transmitted to the UE 701 (through the MBS radio bearer 743), simultaneously to the other UEs belonging to the same multicast group.

The target gNB 711 can send a UE context release to the source gNB 710, so that the source gNB 710 can delete the UE context of the UE 701. Besides, if the UE 701 was the only UE receiving MBS multicast data in the cell controlled by the gNB 710, the source gNB 710 can release the radio resources associated to the UE 701, and can stop receiving the MBS multicast data from the core network 702. To minimize or to prevent data loss during the MBS traffic migration, any data buffered in the source gNB 710 may be moved to the target gNB 711 and then transmitted to the UE 701 (this step is not shown in FIG. 7).

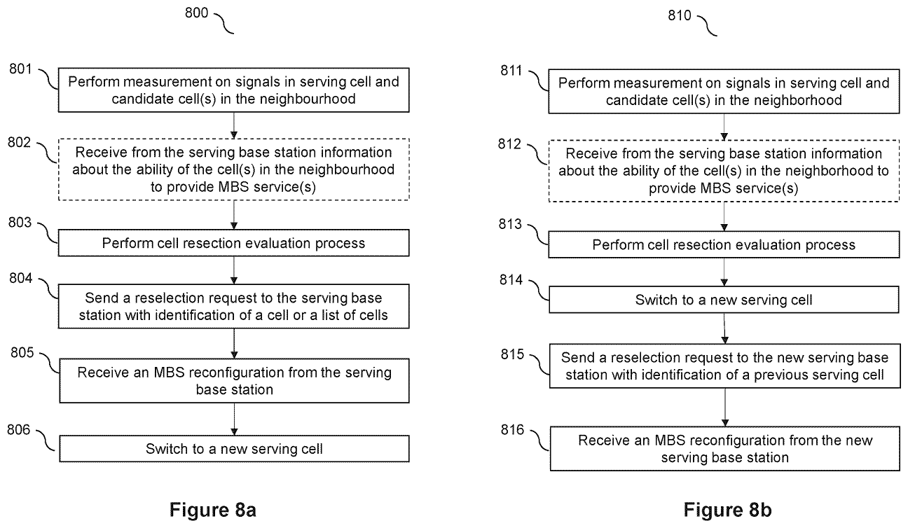

FIG. 8a illustrates, using flowchart 800, an example method performed at a UE for supporting cell reselection in accordance with embodiments of the invention. The UE may be UE 101 of FIG. 1a in the serving cell 120 controlled by serving base station 110 and may comprise the UE 205 of FIG. 2, with the method being performed by the processor 215. The UE is in RRC_INACTIVE state and is receiving MBS multicast data (i.e. the UE has one or more active MBS sessions).

At step 801, the UE 101 performs measurement on signals received at the UE from the one or more candidate cells (e.g. neighbouring cells such as cell 121). Measurements may also be performed on signals received at the UE 101 from the serving cell 120. For example, the UE 101 measures one or more parameters, such as the reference signal received power (RSRP), or reference signal received quality (RSRQ), of a signal received from the candidate or serving cell. Measurements may be performed on received Signal Synchronization Block (SSB). Thus, the UE 101 performs measurement on signals in serving cell and candidate cell(s) in the neighborhood. Optionally, at step 802, the UE 101 receives from the serving base station 110 information about the ability of the cell(s) in the neighborhood to provide MBS service(s) (e.g. whether one or more candidate cells can support a MBS service for the UE): it corresponds to the message 630 in the FIG. 6. At step 803, the UE 101 executes the cell reselection evaluation process (step 621 in the FIG. 6) based on the measurement performed at step 801 and possibly on the information received at step 802. At step 804, the UE 101 sends a reselection request to the serving base station 110 with identification of a cell (e.g, where the UE 101 has selected a new serving cell) or a list of cells (e.g. where the source or serving base station is to make the selection of the new serving cell or target base station) selected at step 803 (it corresponds to the message 631 in the FIG. 6). At step 805, the UE 101 receives an MBS reconfiguration message from the serving base station 110 containing the information to receive the MBS multicast data for the one or more active MBS sessions in the new serving cell. The MBS reconfiguration message corresponds to the message 634 in the FIG. 6. Finally, at step 806 the UE 101 switches cell and camps on the new serving cell and configures its user plane to receive the MBS multicast data from the new serving cell based on the received configuration information.

FIG. 8b illustrates, using flowchart 810, another example method performed at a UE for supporting cell reselection in accordance with embodiments of the invention. The UE may be UE 101 of FIGS. 1a and 1b and may comprise the UE 205 of FIG. 2, with the method being performed by the processor 215. The UE is in RRC_INACTIVE state and is receiving MBS multicast data (i.e. the UE has one or more active MBS sessions).

At step 811, the UE 101 performs measurement on signals received at the UE from the one or more candidate cells (e.g. neighbouring cells such as cell 121). Measurements may also be performed on signals received at the UE 101 from the serving cell 120. For example, the UE 101 measures one or more parameters, such as the reference signal received power (RSRP), or reference signal received quality (RSRQ), of a signal received from the candidate or serving cell. Measurements may be performed on received Signal Synchronization Block (SSB). Thus, the UE 101 performs measurement on signals in serving cell and candidate cell(s) in the neighborhood. Optionally, at step 812, the UE 101 receives from the serving base station 110 information about the ability of the cell(s) in the neighborhood to provide MBS service(s) (e.g. whether one or more candidate cells can support a MBS service for the UE): it corresponds to the message 730 in the FIG. 7. At step 813, the UE 101 executes the cell reselection evaluation process (step 721 in the FIG. 7) based on the measurement performed at step 811 and possibly on the information received at step 812 and selects a new serving cell. At step 814, the UE 101 switches cell and camps on the new serving cell selected at step 813 (step 722 in FIG. 7). At step 815, the UE 101 sends a reselection request to the target base station (or new serving base station) controlling the target cell selected as the new serving cell. It corresponds to the message 732 in the FIG. 7 that may include identification of the previous serving cell (i.e. last serving cell before the UE switched to the new serving cell), such as the gNB ID or cell ID, and identification of the MBS multicast service(s) (e.g. the one or more active MBS sessions) the UE 101 is receiving. At step 816, the UE 101 receives an MBS reconfiguration message from the target base station containing the configuration information to receive the MBS multicast data in the new serving cell and configures its user plane to receive the MBS multicast data from the new serving cell based on the received configuration information. The MBS reconfiguration message corresponds to the message 735 in the FIG. 7.

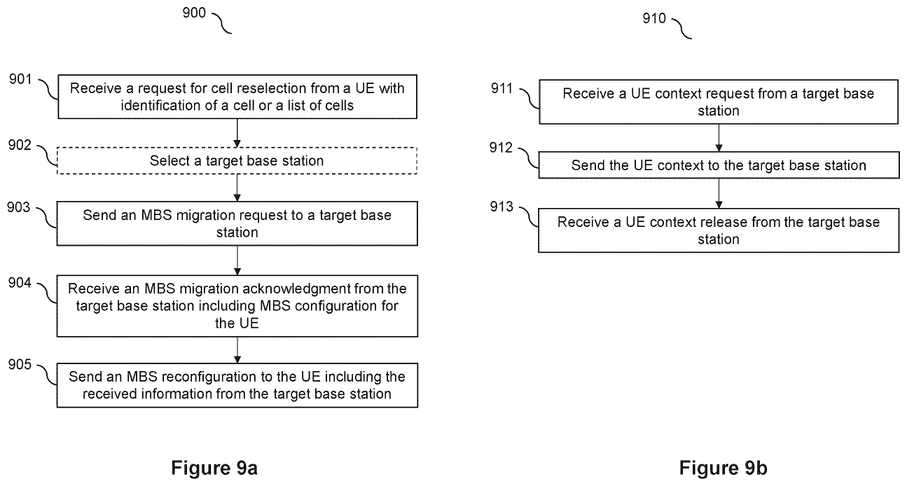

FIG. 9a illustrates, using flowchart 900, an example method performed at a source or serving base station of a serving cell to support cell reselection of a UE in RRC_INACTIVE state and receiving MBS multicast data (i.e. the UE has one or more active MBS sessions) in accordance with embodiments of the invention. The source base station may be the gNB 110 of FIG. 1a and may comprise the base station/gNB 305 of FIG. 3, with the method being performed by the processor 315.

At step 901, the base station 110 receives a request for cell reselection from a UE with identification of a suitable cell or a list of suitable cells (it corresponds to the message 631 in the FIG. 6). Optionally at step 902, the base station 110 selects a target base station controlling a cell among the multiple suitable cells identified at step 901. At step 903, the base station 110 sends an MBS migration request to the target base station controlling the suitable cell (selected by the UE or the base station 110). The MBS migration request corresponds to the message 632 in the FIG. 6, and it may include the UE context containing information related to the MBS session(s) the UE has joined. At step 904, the base station 110 receives an MBS migration acknowledgment from the target base station including MBS configuration for the UE to receive MBS multicast data from the target base station. It corresponds to the message 633 in the FIG. 6 (e.g. a migration accept message as discussed above). At step 905, the base station 110 sends an MBS reconfiguration to the UE including the MBS configuration information received from the target base station. It corresponds to the message 634 in the FIG. 6.

FIG. 9b illustrates, using flowchart 910, another example method performed at a source base station of a previous serving cell of a UE to support cell reselection of a UE operating in a non-connected RRC state with one or more active data sessions (e.g. the UE is in RRC_INACTIVE state and receiving MBS multicast data) in accordance with embodiments of the invention. The UE has switched from the previous serving cell (or last serving cell) to a new serving cell controlled by a target base station. The source base station may be the gNB 110 of FIGS. 1a and 1b and may comprise the base station/gNB 305 of FIG. 3, with the method being performed by the processor 315.

At step 911, the base station 110 receives, from a target base station of the new serving cell, a UE context request message (e.g. context request message) for requesting context information. The context request message includes identification information for identifying the UE. The context request message may further include information requesting context information for the one or more active data sessions. In an example, this message corresponds to the message 733 in the FIG. 7, and identifies a UE in RRC_INACTIVE state and receiving MBS multicast data (i.e. the UE has one or more active MBS sessions). In response to the context request message, the source base station 110 sends a context message including context information associated with the UE and the one or more data sessions (e.g. session identification information identifying the one or more active data sessions). For example, at step 912, the base station 110 sends the UE context to the target base station. It corresponds to the message 734 in the FIG. 7 that may include the identifier(s) of the MBS session(s) the UE 701 is listening to. At step 913, the base station 110 may receive a UE context release from the target base station indicating that the base station can delete the UE context stored at the base station, and thus may release the radio resources associated with the UE, and may stop the reception of the associated MBS multicast data from the core network. The UE context release corresponds to the message 737 in the FIG. 7.

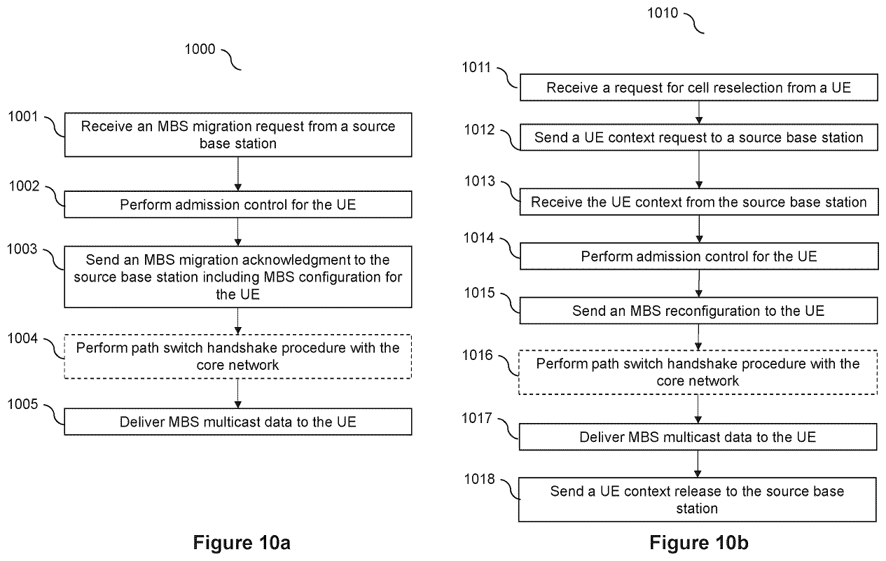

FIG. 10a illustrates, using flowchart 1000, an example method performed at a target base station of a target cell to support cell reselection of a UE in RRC_INACTIVE state and receiving MBS multicast data (i.e. the UE has one or more active MBS sessions) in accordance with embodiments of the invention. The target cell has been selected as a new serving cell for the UE. The target base station may be the gNB 111 of FIG. 1a and may comprise the base station/gNB 305 of FIG. 3, with the method being performed by the processor 315.

At step 1001, the base station 111 receives an MBS migration request from a source base station of the serving cell (i.e. the current serving cell). It corresponds to the message 632 in the FIG. 6, and it includes the UE context containing information related to the MBS session(s) the UE has joined. At step 1002, the base station 111 performs the admission control to decide whether to accept or not the MBS migration request. It corresponds to the step 622 in the FIG. 6. If the base station 111 has accepted the request, at step 1003 the base station 111 sends an MBS migration acknowledgment to the source base station including MBS configuration for the UE to receive MBS multicast data. It corresponds to the message 633 in the FIG. 6 (e.g. migration accept message). Optionally at step 1004, the base station may 111 perform the path switch handshake procedure toward the core network 102 to request the delivery of the MBS multicast data to the base station 111 to be sent to the UE. It corresponds to the procedure 637 in the FIG. 6. At step 1005, the base station 111 has setup the necessary radio resources and can deliver the MBS multicast data to the UE.

FIG. 10b illustrates, using flowchart 1010, another example method performed at a target base station to support cell reselection of a UE in RRC_INACTIVE state and receiving MBS multicast data (i.e. the UE has one or more active MBS sessions) in accordance with embodiments of the invention. The target base station may be the gNB 111 of FIGS. 1a and 1b and may comprise the base station/gNB 305 of FIG. 3, with the method being performed by the processor 315.

At step 1011, the base station 111 receives a reselection request from a UE. It corresponds to the message 732 in the FIG. 7 that may include identification of the previous serving cell and identification of the MBS multicast service(s) the UE is receiving. At step 1012, the base station 111 sends a UE context request message to the source base station controlling the serving cell identified in the reselection request. The UE context request corresponds to the message 733 in the FIG. 7 and identifies the UE in RRC_INACTIVE state and receiving MBS multicast data. At step 1013, the base station 111 receives the UE context from the source base station. It corresponds to the message 734 in the FIG. 7 that may include the identifier(s) of the MBS session(s) the UE is listening to. At step 1014, the base station 111 performs the admission control to decide whether to accept or not the request for reselection with MBS multicast service. It corresponds to the step 723 in the FIG. 7. If the base station 111 has accepted the request, at step 1015 the base station 111 sends to the UE an MBS reconfiguration message containing the information to receive the MBS multicast data in the cell the UE is camping on. Optionally, at step 1016 the base station 111 may perform the path switch handshake procedure toward the core network 102 to request the delivery of the MBS multicast data to the base station 111 to be sent to the UE. It corresponds to procedure 736 in the FIG. 7. At step 1017, the base station 111 has setup the necessary radio resources and can deliver the MBS multicast data to the UE. At step 1018, the base station sends a UE context release to the source base station. It corresponds to the message 737 in the FIG. 7.

One of the objectives of the work item Release 18 for enhancements of NR Multicast and Broadcast Services (MBS), as described in the Work Item Description (WID) RP-221458 is to specify support of multicast reception by UEs in RRC_INACTIVE state with Point-to-Multipoint (PTM) configuration for UEs receiving multicast in RRC_INACTIVE state, and a study of the impact of mobility and state transitions for UEs receiving multicast in RRC_INACTIVE (seamless/lossless mobility is not required).

Despite this objective not requiring seamless/lossless mobility, a moving UE receiving MBS multicast data in RRC_INACTIVE state, should preferably select to cells where the MBS service is available.

In RRC_CONNECTED state, the handover procedure is controlled by the network that can ensure the MBS multicast data delivery in a new serving cell when the UE is moving (provided the new serving cell is part of the MBS service area). Indeed, the source gNB can select a target gNB providing the same MBS service, or it may trigger the delivery through the handover request to the target gNB. Besides, the handover procedure in RRC_CONNECTED state includes the RRC Reconfiguration of the UE, enabling the UE to receive the MBS configuration to receive the MBS multicast data from the target gNB in a new serving cell.

In RRC_INACTIVE state, the cell reselection process as specified in 3GPP TS 38.304 v17.0.0 is executed by the UE, which will switch from one cell to another one without interactions with the network. Thus, several issues may prevent a UE from continuing to receive MBS multicast data after cell reselection. First, the UE may select a target cell that is controlled by a target gNB that is not currently delivering the MBS multicast data. Moreover, even if the target gNB is providing the same MBS multicast service, the target gNB is not aware of the new UE interested in receiving the MBS service, and it may not be able to provide the proper configuration to the new UE. As an MBS multicast service may be reserved to a restricted set of UEs having the authorization to receive it, there are some situations where the MBS configuration cannot be broadcasted (for example using the same mechanism as for handling the broadcast mobility in RRC_IDLE/RRC_INACTIVE).

Thus, the following observations can be made:
1) In RRC_INACTIVE state, a moving UE executes the cell reselection process and will switch from one cell to another one without interactions with the network.
2) A moving UE receiving a MBS multicast service in RRC_INACTIVE state, may switch to a new cell where the MBS multicast data are not currently delivered.
3) A moving UE receiving an MBS multicast service in RRC_INACTIVE and camping on a new cell, may not get the configuration to continue receiving the MBS multicast service in the new cell.

From these observations, it appears that new mechanisms shall be introduced to enable a moving UE in RRC_INACTIVE state to continue receiving a MBS multicast service while switching to new cells. The objective being to avoid the UE to resume in RRC_CONNECTED state, as this would remove the benefits of keeping the UE in RRC_INACTIVE as mentioned in RP-221458.

Thus, as a first proposal, it is proposed to provide solutions enabling a moving UE in RRC_INACTIVE state to continue receiving MBS multicast service while the UE switches to new cells, and keeping the UE in RRC_INACTIVE state.

In an example, as part of the solutions, a UE may send a notification to the network when the UE has identified a new cell to camp on during the cell reselection process. This notification may be conveyed in a message sent either to the source gNB or to the target gNB, depending on whether the cell switching occurred before or after the notification is sent.

In case the notification is sent to the source gNB before cell switching, it may include an identification of the selected cell in the cell reselection process. In case the notification is sent to the target gNB, it may include an identification of the source gNB and of the MBS service the UE is receiving.

Then, the network may be able to apply mechanisms to ensure the delivery of the MBS multicast data in the selected cell, as for a UE in RRC_CONNECTED state, but keeping the UE in RRC_INACTIVE state.

As a second proposal, a UE receiving MBS multicast data in RRC_INACTIVE state, may send a notification to the network when the UE has identified a new cell to camp on during the cell reselection process.

In the above, an enhancement of cell reselection process for the Release 18 has been proposed, to enable a continuous reception of MBS multicast data for a UE staying in RRC_INACTIVE state.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method for supporting cell reselection for a User Equipment, UE, the UE operating in a non-connected RRC state with one or more active MBS multicast sessions, the method at the UE comprising:
sending a request message for receiving the one or more active MBS multicast sessions from a target base station of a new serving cell;
receiving a configuration message including configuration information associated with the target base station for the one or more active MBS multicast sessions, the configuration information including MBS bearer configuration information for the one or more active MBS multicast sessions in the new serving cell; and
configuring the UE for receiving data of the one or more active MBS multicast sessions from the target base station in the new serving cell based on the configuration information.

2. The method of claim 1, further comprising:
switching to the new serving cell.

3. The method of claim 2, further comprising:
after configuring the UE and after switching to the new serving cell, receiving, from the target base station, data for the one or more active MBS multicast sessions.

4. (canceled)

5. The method of claim 1, wherein configuring comprises updating the radio configuration of the UE according to the received MBS bearer configuration information.

6. The method of claim 1, further comprising:
selecting one or more suitable cells for a new serving cell for the UE,
wherein the new serving cell is one of the selected one or more suitable cells.

7-10. (canceled)

11. The method of claim 6, wherein selecting comprises selecting one suitable cell as the new serving cell for the UE, wherein the target base station is a base station of the one suitable cell selected as the new serving cell,
wherein sending a request message comprises sending the request message to the target base station, and
wherein receiving a configuration message, comprises receiving the configuration message from the target base station.

12. The method of claim 11, wherein the request message includes identification information identifying a source base station of a serving cell for the UE.

13. The method of claim 11, wherein the request message includes session identification information identifying the one or more active MBS multicast sessions.

14. The method of claim 11, further comprising:
switching to the new serving cell before sending the request message to the target base station.

15-19. (canceled)

20. A method at a target base station of a new serving cell of a User Equipment, UE, the UE operating in a non-connected RRC state with one or more active MBS multicast sessions, the UE having switched from a previous serving cell to the new serving cell, the method comprising:
receiving, from the UE, a request message for receiving the one or more active MBS multicast sessions from the target base station of the new serving cell;
sending, to a source base station of the previous serving cell, a context request message;
receiving, from the source base station, a context message including context information associated with the UE and the one or more active MBS multicast sessions; and
sending, to the UE, a configuration message including configuration information associated with the target base station for the one or more active MBS multicast sessions, the configuration information including MBS bearer configuration information for the one or more active MBS multicast sessions in the new serving cell.

21. The method of claim 20, wherein the request message includes identification information identifying the source base station of the previous serving cell.

22. The method of claim 20, wherein the request message includes session identification information identifying the one or more active MBS multicast sessions.

23. The method of claim 20, wherein the context request message includes identification information for identifying the UE.

24. The method of claim 20, further comprising:
in response to receiving the context message, determining whether to accept or not the request from the UE,
wherein sending a configuration message, comprises sending the configuration message in response to determining to accept the request.

25. The method of claim 20, wherein the request message is a RRCResumeRequest message or a RRCResumeRequest1 message including information indicating the UE is to perform cell reselection to receive multicast data.

26-34. (canceled)

35. Apparatus for a User Equipment, UE, the apparatus comprising:
one or more processing units configured, when the UE operates in a non-connected RRC state with one or more active MBS multicast sessions, to:
send a request message for receiving the one or more active MBS multicast sessions from a target base station of a new serving cell;
receive a configuration message including configuration information associated with the target base station for the one or more active MBS multicast sessions, the configuration information including MBS bearer configuration information for the one or more active MBS multicast sessions in the new serving cell; and
configure the UE for receiving data of the one or more active MBS multicast sessions from the target base station in the new serving cell based on the configuration information.

36-38. (canceled)

39. Apparatus for a base station, the apparatus comprising:
one or more processing units configured, when the base station controls a new serving cell of a UE operating in a non-connected RRC state with one or more active MBS multicast sessions, the UE having switched from a previous serving cell to the new serving cell, to:
receive, from the UE, a request message for receiving the one or more active MBS multicast sessions from the base station of the new serving cell;
send, to a source base station of the previous serving cell, a context request message;
receive, from the source base station, a context message including context information associated with the UE and the one or more active MBS multicast sessions; and
send, to the UE, a configuration message including configuration information associated with the target base station for the one or more active MBS multicast sessions, the configuration information including MBS bearer configuration information for the one or more active MBS multicast sessions in the new serving cell.

40-47. (canceled)

48. A non-transitory computer-readable storage medium carrying a computer program comprising instructions which, when the program is executed by a computer of a User Equipment, UE, the UE operating in a non-connected RRC state with one or more active MBS multicast sessions, cause the computer to:
send a request message for receiving the one or more active MBS multicast sessions from a target base station of a new serving cell;
receive a configuration message including configuration information associated with the target base station for the one or more active MBS multicast sessions, the configuration information including MBS bearer configuration information for the one or more active MBS multicast sessions in the new serving cell; and
configure the UE for receiving data of the one or more active MBS multicast sessions from the target base station in the new serving cell based on the configuration information.

49. The apparatus of claim 35, wherein the one or more processing units are further configured to switch the UE to the new serving cell.

50. The apparatus of claim 35, wherein the one or more processing units are configured to configure the UE for receiving data by updating the radio configuration of the UE according to the received MBS bearer configuration information.

51. The apparatus of claim 35, wherein the one or more processing units are further configured to:
select one or more suitable cells for a new serving cell for the UE,
wherein the new serving cell is one of the selected one or more suitable cells.

52. The apparatus of claim 51, wherein the one or more processing units are configured to:
select one or more suitable cells by selecting one suitable cell as the new serving cell for the UE, wherein the target base station is a base station of the one suitable cell selected as the new serving cell,
send a request message by sending the request message to the target base station, and
receive a configuration message by receiving the configuration message from the target base station.

53. The apparatus of claim 52, wherein the request message includes identification information identifying a source base station of a serving cell for the UE.

54. The apparatus of claim 35, wherein the one or more processing units are further configured to:
switch the UE to the new serving cell before sending the request message to the target base station.

55. The apparatus of claim 39, wherein the request message includes identification information identifying the source base station of the previous serving cell.

56. The apparatus of claim 39, wherein the context request message includes identification information for identifying the UE.

57. The apparatus of claim 39, wherein the one or more processing units are further configured to:
in response to receiving the context message, determine whether to accept or not the request from the UE,
wherein the one or more processing units are configured to send a configuration message by sending the configuration message in response to determining to accept the request.
